(19) United States
(12) Patent Application Publication
(10) Pub. No.: US 2024/0012924 A1
(43) Pub. Date: Jan. 11, 2024

(54) TIME AND EVENT DELAYING SHARING OF CONTENT WITH SPECIFIC RULE SETS

(71) Applicant: Life Record Holdings, Inc., Thornton, CO (US)

(72) Inventors: Cameron T. Kidd, Thornton, CO (US); David M. Tamm, Thornton, CO (US)

(21) Appl. No.: 17/989,537

(22) Filed: Nov. 17, 2022

Related U.S. Application Data
(60) Provisional application No. 63/388,175, filed on Jul. 11, 2022.

(51) Int. Cl. G06F 21/62

(52) U.S. Cl. CPC G06F 21/6218

(57) ABSTRACT

Provided are processes for content path creation and time and event delayed sharing of content paths. The processes may employ artificial intelligence techniques tasked with the extraction (or categorization) of content items (or other identification and classification of data of interest) from various sources. Some processes may determine prompts based on content provided in relation to a framework to solicit additional content for analysis and presentation of the content along a determined path through the content. Some processed may identify events based on ingested content to determine whether to permit user access to a content path based on rules governing the access.

### CROSS-REFERENCE TO RELATED APPLICATIONS

The present patent application claims the benefit of U.S. Provisional Patent Application No. 63/388,175, filed 11 Jul. 2022. The entire contents of each aforementioned patent filing is incorporated by reference herein.

### BACKGROUND

### 1. Field

The present disclosure relates generally to content creation and, more specifically, to determining user permissions to access portions of a data structure within which content is organized.

### 2. Description of the Related Art

Existing social platforms focus on elevating individual posts or other pieces of content, largely in isolation, such as based on reactions to the post (whether positive or negative). For example, highly viewed or interacted with posts (which may contain an image, video, text, or combination thereof) may be elevated relative to other posts that are less viewed or interacted with by users of a social platform. In some cases, algorithms of a social platform determine whether to elevate a post relative to other posts based on whether the system infers that the post is more likely to retain engagement of a user, such as based on prior interactions of the user with content on the social platform.

The above and other existing examples of social platforms are post-centric in that they focus on discrete instances of a user posting content. While users may share a post, comment on a post, or repost an existing post via a variety of different mechanisms, users generally lack the ability to create deeper content experiences on these platforms. Indeed, the very nature of scrolling through a plethora of different posts by different users stands in contrast to creation of deeper content experiences. Moreover, posts are typically submitted out onto a social platform, briefly elevated, and then fade quickly into forgotten history, never to be elevated again in almost all cases unless a user intentionally finds and shares the post.

### SUMMARY

The following is a non-exhaustive listing of some aspects of the present techniques. These and other aspects are described in the following disclosure.

Some aspects include a computer-implemented process of generating a framework for content path creation. In some aspects processes may employ artificial intelligence techniques tasked with the extraction (or categorization) of content items (or other identification and classification of data of interest) from various sources to determine descriptors of the content items. In some aspects processes may determine prompts based on the descriptors of content items provided in relation to a framework to solicit additional content items for analysis and determination of subsequent prompts. In some aspects processes present content items based on a path through nodes corresponding to one or more content items obtained in response to a prompt.

Some aspects include a computer-implemented process of time and event delayed sharing of a content path or portion thereof. In some aspects processes may employ artificial intelligence techniques tasked with the extraction (or categorization) of content items (or other identification and classification of data of interest) from various sources to identify events and properties of events. Some rules specified for a content path or portion thereof may specify criteria for governing access based on events. Example criteria may be based on types of events and their properties that are identifiable by the artificial intelligence techniques. Some rules specified for the content path or portion thereof may specify criteria for one or more users to which access is to be granted when event criteria is met. In response to a determination that criteria of one or more rules is met by an event to permit one or more users access to a content path or portion thereof, the process notifies the one or more users of updated permissions of the users to access the content path or portion thereof.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is an example computing environment for implementing a content path creation system in accordance with some embodiments;

FIG. 2 is an example environment for content path creation within which the present techniques may be implemented in accordance with some example embodiments;

FIG. 3 is an example machine learning model in accordance with some embodiments;

FIG. 4 illustrates an example nodal data structure by which the present techniques may be implemented;

FIG. 5 is an example process of content path creation by which the present techniques may be implemented;

FIG. 6 is an example environment for time and event delayed sharing within which the present techniques may be implemented in accordance with some example embodiments;

FIG. 7 is an example process for time and event delayed sharing by which the present techniques may be implemented;

FIG. 8 is a physical architecture block diagram that shows an example of a computing device (or data processing system) by which some aspects of the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of content creation platforms and machine learning. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Traditional techniques employing machine learning mechanisms on social platforms are typically concerned with elevation of posts to drive user engagement, filtering of harmful content, and advertisement placement, among other metrics that are largely transactional with respect to increasing platform value based on user engagement. These machine learning mechanisms are not employed to aid users in creating content, let alone building on existing content over time.

Embodiments described herein may utilize techniques to identify data of interest from various sources for content creation. Traditional techniques employed in other domains for identifying data of interest have traditionally relied on inputs obtained from structured data sets stored in a database, or other corpuses, to output meaningful results. Developing and curating such structured data sets is not only burdensome on users but is limited in deployment across data sets structured by different users or within different contexts. In many potential applications, whether existing or new or unforeseen, a preliminary task of structuring data within a structured data set for processing is often impractical. Further, many types of machine learning are particularly data inefficient, often requiring relatively large training sets to train the model. As a result, such models are often not suitable for use cases in which training data is scarce or particularly expensive to acquire.

Embodiments described herein to generate frameworks for content creation may employ artificial intelligence techniques tasked with the extraction (or categorization) of content items (or other identification and classification of data of interest) from various sources. Where traditional techniques have been employed for such purposes to process unstructured input data, these attempts are characterized by a propensity to either produce erroneous results or suffer from too narrow of a focus to permit broader applicability, such as for reasons explained below.

Unstructured inputs, like natural language texts, images, video, and the like, in contrast to structured data sets are more difficult to process. One reason is the challenge of determining a shared context between content items in a data set, or between multiple subsets of content items within a data set that have a shared context (e.g., that relates multiple sub-contexts) between those subsets, and optimizing a model that generates a framework spanning a shared context and that structures, like in a hierarchical structure defining one or more time-series, a plurality content items. This tradeoff becomes particularly important when optimization operations are expensive, for instance, computationally, in terms of latency constraints, or in terms of time and effort of a human to develop a framework that permits exploration. Existing approaches are often not well suited for a process constrained by a relatively tight interrogation budget, i.e., where practical constraints limit the number of content items at hand to learn about a shared context. Particularly with unstructured, high-dimensionality data, existing approaches often fail to consistently infer the right shared context.

Some embodiments disclosed herein mitigate these and other issues with a computational technique that determines dynamically, while learning a framework, based on content item selections to previous prompts, when to transition from breadth of prompts (e.g., different time-series) to prioritizing depth of prompts (e.g., within a time-series) across a shared context. Optimizing machine learning techniques to navigate the combination of depth and breadth in a dynamic noisy environment of unstructured data sets has potentially profound implications on striking a balance between productive inquiry and user fatigue when developing or employing a framework to coherently organize content items which may be selected in asynchronous or unchronological ways. The techniques are expected to have wide applicability, and it is expected that a variety of forms of artificial intelligence may be improved through use of techniques that efficiently balance breadth and depth while learning. In some cases, iterative learning approaches are used both during development and employment of a framework, such as to afford user exploration and refinement of a framework during employment without a requirement to account for each possibly relevant context during initial development of the framework.

None of the preceding discussion of trade-offs should be taken to suggest that any technique is disclaimed, as the approaches described below may be implemented in combination with the various techniques described above.

To mitigate some or all of the above issues, some embodiments train one or more machine learning models (which may include one or more semi-supervised machine learning models, like a multiheaded attention transformer, among others) on a data set, or different data sets, which may include one or more existing content paths, by which a framework for generating prompts for content items may be determined. Further, embodiments employing such a framework may involve an iterative learning process that balances between depth and breadth exploration to solicit or select content items with attention to a shared context.

Translating this intuition into code, however, is non-trivial. Moravec's paradox holds that there are certain tasks that are simultaneously relatively easy for even a human child to perform (like detecting a dog in a photograph) and enormously complex and challenging for a computer to perform. This is an example of such a scenario. There is no simple mental process that may be translated directly into computer code to balance between depth and breadth for soliciting content. The dimensionality of inputs and enormous number of ways contextually relevant content may be organized or articulated can evolve and prevent the articulation of simple rules that mimic what goes on in the mind of a content creator or other entity. As such, the following should not be characterized as simply implementing a mental process with a computer, as an algorithm different from mental approaches, and one more tractable for computer operations, is used in accordance with techniques described herein.

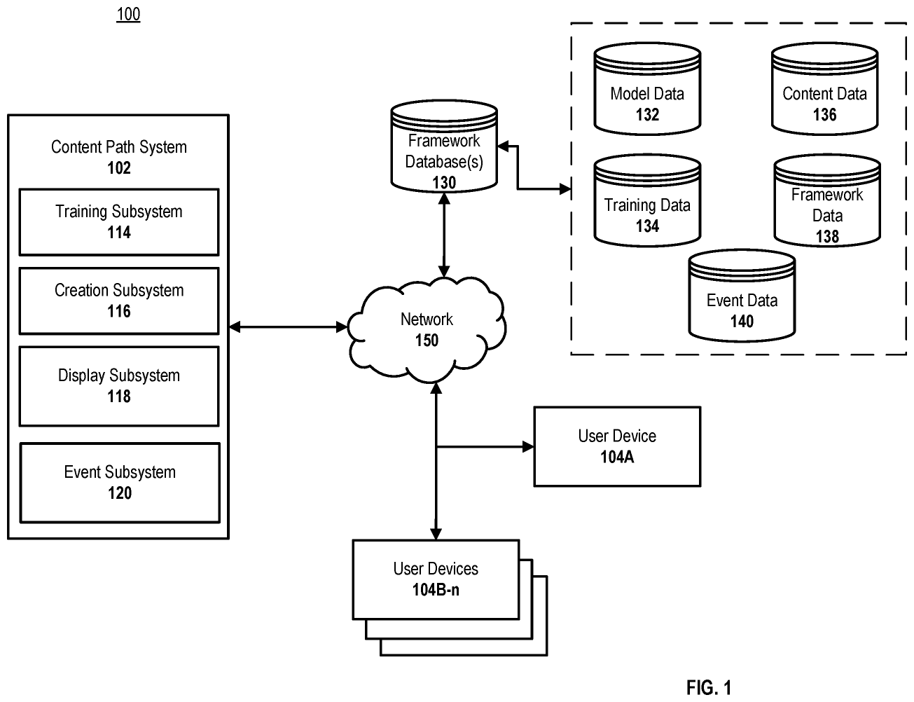

FIG. 1 illustrates an example computing environment 100 for implementing frameworks for content paths in accordance with some embodiments. The computing environment 100 may include one or more user devices 104, servers 102, and databases 130. While only one server, e.g., content path system 102, and database, e.g., framework database 130, are shown, the content path system or database may include multiple compute or storage servers or be implemented by a distributed system including multiple compute or storage nodes, and functionality or data stored may be distributed across multiple ones of nodes or servers. Each of the content path system 102, database 130, and user devices 104 (or other components described herein) may communicate with one another (which is not to suggest that a component need to communicate with every other component) via a network 150, such as the internet, which may include public or private local area networks. Each of these computing devices may have the features of a computing system like that described herein, including a processor and memory. In some embodiments, the functionality of computing systems described herein may be implemented with program code or other instructions stored on a tangible, non-transitory, machine-readable medium, such that when that program code is executed by one or more processors, the described functionality is effectuated.

The content path system 102, in some embodiments, may employ one or more models which are trained and are then executed to respond to novel inputs during runtime on various types of physical architectures. Examples include client-server architectures, decentralized architectures (for instance in on a blockchain-based distributed computing platform), or as monolithic applications running on a single computing device or collection of such computing devices. In some embodiments, users of the content path system 102 may include various content creators and consumers of that created content, each of which may have access to a computing device (e.g., a user device 104a-n) with which the respective user creates or interacts (e.g., visually on a display screen, audibly with a speaker or microphone, or other user input/output interfaces) with content. Users may interact with content of other users, such as via paths through the content. For example, the user of user device 104A may utilize the content path system 102 to create a content path that other users via their respective user devices 104B-n (or a subset thereof based on user permissions) may access to engage with the content along the content path (but not other content of the user that is not along the path).

In some embodiments, the content path system 102 may be trained to determine prompts based on content provided in relation to a framework. For example, the content path system 102 may use one or more models trained on training data sets for processing content items, such as to determine textual information about the content items. Some example models may include audio classification models, image classification models, and optical character recognition models. Each of these models may determine information, like textual information, that corresponds to or is descriptive of content in another domain (e.g., audio or video which may include speech, image or video data which may contain text or scenes or objects that may be described textually, etc.). The output of these models may thus determine textual information corresponding to content items in domains that are not natively textually based. The resulting textual information, like descriptors, may be associated with the respective content items.

In turn, the textual information determined about content items and the textual information of other content items, such as those which natively contain textual content, like documents, notes, stories, poems, dialogue, etc. may be analyzed by one or more other models. For example, another model, like a natural language processing (NLP) model, examples of which may include an attention-based transformer, may be trained on a training data set for processing the textual information determined about content items in other domains and text-based content (e.g., textual content items, like sentences, paragraphs, poems, stories, eulogies, etc.). In some examples, different NLP models may be applied to the textual information of different content items. For example, descriptors associated with an image or frames of a video may be analyzed using a first NLP model, textual content determined from audio dialogue or a textual dialogue may be analyzed using a second NLP model, and textual content determined from audio monologue or other texts may be analyzed using a third NLP. In other examples, a single natural NLP model or different types of the NLP model may be used. Different NLP models of same or different types may be trained on different training sets to determine results relevant to different types of textual content characterized in respective training sets.

In some examples, results output by a model may be provided to another model. For example, an image classification model may infer textual information, like descriptors, about what is depicted in image data, and a NLP model may determine content related to that theme, such as how that theme is described or represented in a broader corpus of texts. As an illustrative example, an image of a beach may be associated with one or more descriptors such as “beach, child, sunny, sandcastle, etc.” based on classification of scene and objects within the image, and those descriptors may be provided to the NLP to infer prompts for additional content items, such as based on how beaches, children, weather, and sandcastles, etc. are described in the broader corpus of texts. For example, the NLP model might provide an output like, “the child built the sandcastle before the tide washed it away,” and the content path system 102 may restructure the output in the form of a question, like one or more prompts to solicit additional content items, such as “who built the sandcastle?” or “did the tide wash the sandcastle away?” Additional content items provided in the relation to a prompt may be analyzed, e.g., as described above, and results of the analysis may be associated with the prompt and the prior content item for which the prompt was determined. Thus, for example, relationships, like edges of a graph, may be formed to link different ones of the content items provided by a user to the content path system 102 within a framework.

In some embodiments, the content path system 102 may determine prompts based on content provided in relation to a framework. For example, the content path system 102 may prompt a user for additional information or content within a framework. Example frameworks described herein may correspond to a data structure by which content may be solicited from a user and organized, and data corresponding to those frameworks may be stored as framework data 138 within the framework databases 130. The terminology of a framework within the context of the present disclosure is distinct from that in the sense of how that word is used in computer programming to distinguish between a framework and a library. For example, a framework in the context of the present application may employ an attention-based transformer as a user engages with the framework to center solicitations for content around an original context (e.g., within some boundary, like a threshold distance from the original context).

For example, after a user selection of a framework, such as from a set of frameworks, each of which may be characterized by a relatively general descriptor, like “an experience,” “life milestone,” “legacy preservation,” “project,” etc., the content path system 102 may prompt a user to provide some initial descriptive content. The initial descriptive content may include one or more images, audio, or textual content. For example, a user may select “an experience” and prompted with “What was the experience?” to which a user might select images or video taken at a beach or provide text content like, “North Carolina Beach Trip.” In another example, such as for a selection of “legacy preservation,” the system may prompt a user with “Whose legacy is being preserved?” to which a user might provide text content like a given name or a eulogy. Embodiments may process the received content to determine additional prompts. For example, the system might prompt a user to solicit additional contextually relevant content, like “Who was at the beach?” or “What sights did you see at the beach?” In some examples, the prompts may be relatively specific, like “Did you see any jellyfish or whales while at the beach?” or “Did you visit the tide pools or build or see any sandcastles?” and the like. In various examples, the prompts may be determined based on the content provided by the user and outputs of machine learning models. For example, an attention-based transformer may take, as input, content or information about content provided by a user and output a prediction, like a next sentence, which some embodiments may reform as a question to solicit additional content from a user.

As time goes on, such as after a series of prompts and responses in which a user provides additional content, like within a particular sub-context (e.g., “Who was at the beach?”), the system may determine a prompt for a different sub-context (e.g., “What sights did you see at the beach?”) to solicit additional content. Some embodiments may modify predictions output by a model based on whether their context was previously explored (e.g., “Who was at the beach?”), such as to select a next best prompt (e.g., question) that solicits a different sub-context of content relevant to the original context (e.g., “North Carolina Beach Trip”).

The different sub-contexts explored and for which content is solicited from a user may each correspond to a different branch of a tree-like data structure having an origin, like an entry node, corresponding to the original context. A content item solicited from a user along a branch may correspond to a child node within the tree-like data structure. Each child node may link back to the entry node via one or more edges formed between nodes. In some examples, a link may be formed between two nodes within a sub-context based on a score output by a model, and the scores may be iteratively computed to adjust the links. For example, the system, in response to soliciting content indicating that multiple people were at the beach, e.g., based on identification of multiple names in text content or detection (or identification) of multiple people in an image, may generate content nodes corresponding to each instance of a detected name or person, and each of those content nodes may be linked to a parent content node, e.g., the content that indicated multiple people were at the beach. In turn, the system may generate prompts to further solicit additional content for new content nodes with respect to the different names, and those content nodes may be linked to one or more of the intermediate parent content nodes corresponding to names. For example, Person A and Person B may be implicated in an additional content item that does implicate Person C, and Person C may be implicated in an additional content item alone.

Embodiments of the content path system 102 may include a training subsystem 114, a creation subsystem 116, an event subsystem 120, and a display subsystem 118 by which functionality of the content path system 102, like that described above and elsewhere herein, may be implemented. Functionality of these components or otherwise ascribed to the expert system 102 may be divided in different ways, in some cases among different servers. For example, one or more of these components may be hosted on a server providing content path system 102 functionality, or a server system implemented with a plurality of servers that each, or collectively, execute processes upon data or portions of data like that described herein. In some examples, the framework database 130 may be implemented within the context of the content path system 102, such as by one or more servers or storage servers by which functionalities of components of the content path system 102 are implemented, or separately, such as within a cloud storage system, which the content path system 102 may communicate with to store data and obtained stored data.

The training subsystem 114 may train one or more models, which may include audio classification models, image classification models, optical character recognition models, and NLP models, or other machine learning models (e.g., any model described elsewhere herein). For example, the training subsystem 114 may train one or more neural networks or other models for processing audio, image, text data, or other data associated with content items. Examples of neural networks that can be trained may include, but are not limited to recurrent neural networks, convolutional neural networks, artificial neural networks, among others, which may be trained to process natural language texts or other inputs, like other types of input content items. For example, contents of images or frames of a video may be classified using a convolutional neural network or artificial neural network.

Additionally, other types of models may also be trained to process input content items, such as support vector machines or k-nearest neighbor clustering techniques, which, for example, may be used to classify contents of images or frames of a video or data associated with images or video. For example, a machine learning model, like a neural network or clustering model, may take as input descriptors of content items and time and geolocation data (e.g., like in EXIF data) to infer additional descriptors relevant to a content item based on nearby places of interest and their associated descriptors. Some examples may encode information (e.g., like descriptors) about places of interest and associate one or more places of interest with a tile, like a tile in a plurality of different tiles that bound different geographic areas. Thus, for example, a picture of a dolphin or whale having a geolocation reported off the coast may be associated with a number of descriptors (e.g., ocean, bay, whale watching, cruise) that differ from descriptors (e.g., exhibits, rides, swimming with dolphins) that may be associated with a picture of a dolphin or whale having a geolocation reported at an oceanic amusement park in San Antonio, even where both images are determined to depict relatively similar scenes or objects, like water and a whale or dolphin.

The different models may be trained in different ways (separately or concurrently through end-to-end training), and some models may receive inputs based on the outputs of other models. Training of a model may comprise end-to-end training, or training of different stages (e.g., like sub-models) of a model (e.g., like a pipeline). Some examples may combine these approaches, such as by training a model and then including that model within a model or as a stage of a pipeline trained end-to-end. The training may be performed using data obtained by the server system 102 from the framework database 130 or user devices 104, such as over the network 150. The training subsystem 114 may store, access, or update one or more models in various states of training from within the framework database 130. For example, the training subsystem 114 may access a previously trained machine learning model (or a model undergoing training) and update the model based on newly received (or classified data) and store an updated version of the model within the framework database 130. The training subsystem 114 may access a trained model to process data which in turn may be used to train another model. Thus, the training subsystem 114 may store or access data within the framework database 130, such as data of one or more models 132 and training data 134, and the training subsystem 114 may process such data to train models by which content data 136 may be processed to generate framework data 138. Content data 136 and framework data 138 may be used to further augment training data 134 for one or more models, such as based on the interactions of users (e.g., feedback data) with the content and framework data (e.g., like implicit feedback from viewing or modifying content paths, or other feedback mechanisms like explicit ratings in relation to creating content paths, like relevancy of a prompt to a content item and the like).

In some embodiments, the training subsystem 114 may train a NLP model (or other model) based on training data 134 and store a trained NLP model (or other trained model) within the models data 132. Trained models stored within the models data 132 may be accessed by the content path system 102 and loaded into memory to process inputs, like content items, such as content items obtained from user devices (or other sources) which may be stored in content data 136. Additionally, some models may process inputs that are outputs of another model. For example, descriptors determined to describe a scene of an image by an image classification model may be processed by a NLP model. In some examples, feedback data indicative of a score (e.g., accuracy or relevancy) of a result of processing a content item may be received and, based on that feedback and the quality measure, the natural language text and result may be stored as training data for updating the model.

In some embodiments, a trained NLP model may receive as input, a natural language text, or portions thereof, and output scores indicative of properties of the natural language text. Some examples of scores may indicate a relatedness of the natural language text to one or more themes, like a topic, or descriptor of a topic, which may be identified within a training data set including training records indicating natural language text (or texts) and corresponding theme(s), like a portion of text and a theme classification. In some examples, the NLP model may infer potential themes, such as based on groupings of natural language texts, like a cluster of natural language texts, based on distances between the natural language texts, and infer a potential theme based on a frequency of a word or phrase (or synonyms or synonymous phrases) represented within the cluster. In some examples, n-grams, Long Short Term Memory networks, or other techniques may be utilized in connection with, or instead of, the above techniques to determine theme classifications. One or more potential themes may be assigned to the cluster, and thus the texts within the cluster, whether manually or based on a threshold (e.g., like a ratio of frequency to number of samples within the cluster being below a threshold) or based on a set of sample themes and distance between one or more potential themes and a sample theme (e.g., a sample theme may be assigned automatically when the distance of one or more potential themes and the sample theme is below a threshold).

In some embodiments, a trained NLP model, such as example NLP models implementing a multiheaded attention transformer may receive as input, a natural language text, or portions thereof, which may include one or more descriptors, themes, or portions of natural language text, and output a resulting natural language text based on attention scores resident within the model. For example, an NLP model implemented a multiheaded attention transformer may receive a number of text inputs and output a resulting text based on the inputs and scores for other words in relation to the inputs, and that resulting text may be a sentence or paragraph that is based on the input texts. In some examples, the sentence or paragraph may be human readable prose that may be formatted in or reformatted into a question. Inputs of “water”, “whale”, and “Jessica”, for example, may be processed to output a result of “Jessica went to the aquarium and saw a whale,” which in some examples may be formatted into a question, like “Did Jessica go to the aquarium and see a whale?” Attention mechanisms, such as when fed additional text inputs, may produce different results. For example, “George”, “water”, “ocean”, “whale”, “family” and “Jessica” may lead to a result of “George took the family whale watching on a boat. Jessica saw a whale for the first time,” which may be reformatted into a question or questions, like, “Did you take the family whale watching? Did Jessica see a whale for the first time?” Example results, such as those further along a sequence of outputs, may be selected to query for additional details. For example, the above results may include other related content like, “As the boat pulled out of the harbor the dolphins were playing off the bow,” which may be reformatted into a question such as, “What other animals did you see?” or “Did you see any dolphins?” to prompt for additional content that is often described in relation to inputs but not yet accounted for within the inputs. Thus, for example, the system may process received content to output textual prose that is determined to be descriptive of the content or determined to be contextually relevant to the content.

As noted above, a number of output texts may be generated. In some examples, the output texts may be scored, such as based on a ratio or count of existing descriptors (e.g., descriptive) to new descriptors (e.g., potentially contextually relevant). Output texts exhibiting a higher count of existing descriptors (with few new descriptors) may be determined to be descriptive of the inputs already known, e.g., like a description of the content provided by the user, and these output texts may be suggested as to a user as descriptions of what occurred in an image or video or as a summarization of a longer textual input or dialogue. Users may opt to include these descriptions in connection with provided content, and optionally edit the descriptions, which may be used as feedback indicative of their accuracy. Output texts exhibiting a lower count of existing descriptors may be determined to be potentially relevant to the inputs already known, e.g., like a description of potential outcomes or events that are commonly described with or in relation to the known inputs, and these output texts may be used to generate prompts for additional content. The count of existing descriptors to new descriptors may compared to one or more thresholds to limit the amount of new information attempted to be solicited from the user, e.g., a count of 4:1 may indicate that a question is well anchored contextually to what is known about the content whereas a count of 1:4 may indicate that multiple questions are raised about one aspect that is known about the content. Some embodiments may rank inputs as more (or less) important for soliciting additional content, which may change in different phases of the process, such as to focus solicitation of additional content in relation to different descriptors at different times, e.g., where two or more people are implicated, such as in a family vacation, a person A may be a focus for one phase of prompts while person B may be a focus for another phase of prompts. Selected contextually relevant textual prose may be output as a prompt (e.g., in the form of a question) for soliciting additional content, in some cases in a conversational manner.

Some embodiments of the training subsystem 114 may train an image classification model, which may be a convolutional neural network, on image data which may include various images and frames of video data. In some examples, the image data may include subsets of an image, like an object depicted in the image. The training data may include at least some labeled training data, such as an image associated with one or more labels indicative of content depicted within the image. In some examples, objects may be localized within images and labeled. Some embodiments may use an iterative training process to train the image classification model, such as after obtaining one or more new images or potential or indicated labels for new or current images. The training data may be divided into a training set and a validation set, each set including at least some labeled image data. The training subsystem 114 may train the image classification model on data obtained from repositories of labeled images and iteratively train on image data uploaded by users to the platform, which may be used to improve classification of images over time. The trained image classification model may receive input image data, like new images or video uploaded by users, and output one or more labels in association with an image or frames of a video. In some examples, such as for processing video data, key frames or frames determined to have a quality (e.g., such as based on a filtering of frames to remove blurry or out of white-balanced frames) above a threshold may be selected periodically from a video for classification, such as to reduce the number of frames processed. In some cases, scene change detection (e.g., such as based on a threshold number of changed pixels between different frames) may be used to segment a video for selection of frames deemed likely to include new content for classification. In some examples, object detection and localization (or tracking) (e.g., based on a threshold number of changed pixels within a region of different frames) may be used to select potential objects for classification within a larger scene (e.g., a video of a parade may include a number of different objects that move across the viewpoint of the video from frame to frame).

In some embodiments, the training subsystem 114 may store one or more resulting trained models in memory to be applied to runtime problems, for instance, on a different set of computing devices, at a later time (e.g., more than a day later). In some embodiments, a trained model may be responsive to inputs and a computing device may apply the trained model to produce outputs. For example, the content path subsystem 120 may apply one or more trained models to input content to determine a result. Results may be presented on a user computing device and stored in memory. The present techniques may be applied to various types of models, such as those with non-differentiable optimizations during training. Examples include direct policy learning and behavior cloning in reinforcement learning, and some embodiments may apply the present techniques to learning (e.g., policies or reward functions of) other model-free reinforcement learning models. In some cases, where training involves nondifferentiable optimizations, it may be difficult or impossible to use various forms of training used in other types of machine learning, like gradient descent.

Example of a framework database 130, like that illustrated, may store data about trained models or models undergoing training 132, training data 134, content data 136, and framework data 136. For example, the framework database 130 may include data about one or more models 132 (e.g., one or more iterations thereof, like architectures, hyperparameters, and model parameters adjusted through training) and input type for a model, or other data. In some embodiments, the model data 132 may include parameter values (e.g., values of weights, biases, etc.) of the various models described herein. In some examples, such as in the case of content path creation, which may include a plurality of instances of analysis of content selections by a user, each selection may correspond to an iterative training process or updating of inputs to a model, and the model data 132 may include a record (or a number thereof) corresponding to each instance of an analysis of content, prompt generated, content provided responsive to a prompt, and any user feedback obtained responsive to a respective stage of content path creation.

The creation subsystem 116 evaluates content obtained from one or more sources, such as from the databases 130, user devices 104, or other subsystems of the content path system 102. For example, the creation subsystem 116 may evaluate content that is fed to, or obtained from, the training subsystem 114 and feedback collected from users based on the that data. The creation subsystem 116 may process obtained data during, or after, a user session in which a user uploads, organizes, or otherwise selects content for analysis or use within a framework. The creation subsystem 116 may take inputs from a user device 104, such as content items uploaded from the user device or content items other input into the creation subsystem via a user device. For example, options to select content on the user device 104 for upload or otherwise input content to the creation subsystem 116 for analysis. The options, among other interactive elements, may be displayed via a content path application (not shown) executed by the user device or within a generated interface (e.g., like a web-based interface, like a web-page or via a web-application) including data that may be accessed by the user device (e.g., via a web-browser). Other example interactive elements may include options for engaging with a framework via a user device, such as organization of content items within a framework, modify content items, delete content items, or provide feedback (e.g., from the user or user device) on a framework or analysis of content items.

The creation subsystem 116 may obtain feedback on evaluated content items or collections of content items prior to or after analysis thereof. For example, a user may provide one or more labels or textual description in association with content items uploaded for analysis, or modify one or more labels which may be associated with evaluated content items. Additionally, user responses to prompts, such as whether or not a user provided text, image, audio, or video content, which type of content was provided, may be evaluated (e.g., to determine descriptors that may be used) as feedback in relation to the prompt that solicited the content. Other examples of feedback may include implicit feedback, such as user dwell time or other metrics indicative of user engagement, or explicit user feedback, such as scores, ratings, rankings, or natural language text responses in relation to a content item or content path (e.g., either by the creator or other users interacting with the content path). In some examples, a user may provide explicit feedback by providing or selecting a score or rating via a user interface element, such as to indicate whether a prompt was helpful, whether summarization of a larger text was accurate, or whether classification of an image was accurate. Scores or ratings may be selected via a user interface element on a scale which may indicate a range of possible scores or ratings within a range (such as 1-10, 1-5 stars, positive/neutral/negative, binary positive/negative or other), and in some examples a score may be inferred within a similar range (e.g., as positive/neutral/negative based on whether a user altered none, some, or all of information determined by the creation subsystem 116). The feedback obtained by the creation subsystem 116 may be stored as content data 136 or training data 134 within the framework database 130. Feedback data stored as content data 136 may be selected to training data 134 periodically for training or validation of models stored within the model data 132.

In some embodiments, the display subsystem 118 may obtain data processed by other subsystems of the content path system 102 and generate interfaces corresponding to or including the data. For example, the display subsystem 118 may generate an interface including a plurality of frameworks from which a user may select a framework to create a content path, and the interface may be updated based on selections of content items, analysis of the content items, and organization thereof within the framework. Examples of the display subsystem 118 may display content data 136 based on content paths created by (or with) the content path system 102. For example, a content path, such as based on content uploaded from a user device 104A within a framework, may be selected by the user for viewing on the user device 104A or another user device. The user may permission one or more users of other user devices 104B-n to access some or all of the content uploaded by the user. In some examples, the user may permission other users to view some or all of the content along a content path, or different portions of the content path may be permissioned for access by different subsets of users. In some cases, a first portion of a content path may be accessible to all users of the content path system 102, the first portion and a second portion may be accessible to a first subset of the users, and the first portion, the second portion, and a third portion may be accessible to a second subset of the users (which may be a subset of the first subset, or a different subset). Permissions may be specified for individual users, groups or classes of users, or other criteria by which users via respective user accounts may interact on the platform to govern which users have access to which content paths or portions thereof via the display subsystem 118. For example, a user may form connections with other users (e.g., like within a social graph), invite other users to connect, and organize those connections to specify which users or subsets of user can access content paths created by the user. Some embodiments of the display subsystem 118 may provide a permissions interface by which users may permission other users or groups of users to view or modify content uploaded by the user. In some examples, the permissions interface may provide options to permission other users or groups of users differently for different content paths, portions thereof, or content within content paths. In some examples, a user may permission one or more users to collectively upload content and engage with a framework for collective creation of a content path. The display subsystem 118 may generate, based on permissions of a user to access different content paths or portions thereof, an interface comprising indications of content paths or portions thereof that are available for viewing. In turn, based on a selection of a user to access a given content path or portion thereof, the display subsystem 118 may generate an interface by which the user may interact with the corresponding content, such as by viewing all or some of the content along a content path.

In some embodiments, the display subsystem 118 may generate various web interfaces, like a website, accessible by user devices to view content of content paths, among other data, some examples of which are described above, and additional examples are discussed under respective headings below and throughout the specification. In some embodiments, the display subsystem 118 may provide an application programing interface by which user facing applications may access data for presentation to a user on a user device. Example user facing applications may include various web applications, like a web application accessible from a web browser executed by a user device, or native applications, like an application executable by a user device which may be downloaded by the user device. In either example, the application may generate requests to the API (e.g., like a Restful API) of the display subsystem 118 for content or other data, such as for display to a user via the interface of the user device.

In some embodiments, the event subsystem 120 may identify events and determine whether an event satisfies rules for sharing content with one or more users or otherwise permitting user access to content, such as content within a content path or portion thereof. For example, a user, such as via their user device 104A, may configure rules pertaining to content paths or portions thereof created by the user that govern which and when one or more other users of other user devices 104B-n may access that content. Embodiments of the event subsystem 120 may identify events from content uploaded by users when creating content paths and other sources, such as feeds or crawling of webpages or repositories to obtain content for analysis. When the event subsystem 120 determines that criteria of rules governing access to a given content path or portion thereof is satisfied for a user based on identified events, the event subsystem may update permissions for one or more users to access the given content (e.g., via the display subsystem 118). The event subsystem 120 may cause the display subsystem 118 to indicate to respective users which content is newly accessible based on updated permissions for the respective users. Accordingly, the event subsystem 120 may perform processes to effectuate time and event delayed sharing of content using specific rulesets, which are discussed in greater detail below under the respective heading.

### Content Path Frameworks

Content path frameworks are expected to provide a unique digital interface for creating, exploring, road mapping and organizing content. Content path framework data 138 may be stored within the framework database 130. In some examples, a user selects a framework, such as from a set of frameworks, which aligns with a type or experience or concept which the user would like to explore with a content path. In some examples, rather than a rigid construct, a framework may be relatively fluid, adapting as the user supplies content to the content path system while engaging with the framework. Thus, for example, while a set of different frameworks may be stored as framework data 138, user selection of a framework may cause the content path system 102 to initialize an instance of the framework for the user or data by which the framework operates, like a configuration, which differs for different instances of the framework.

In some examples, an instance of a framework may be an in-training model that is undergoes refinement as the user engages with the framework, such as by selecting or providing content items while interacting with the framework. Specifically, a framework may trained to balance between depth and breadth coverage within a context which the user wishes to explore with a content path. The framework may be trained to hierarchically organize content provided by a user and determine a path through the content (which a user may adjust).

In some examples, a framework includes parameters which guide the user through creation of a content path within a given shared context, which may be characterized by a relatively general descriptor, like “an experience,” “life milestone,” “legacy preservation,” “project,” etc. For example, a framework corresponding to legacy preservation may be selected to capture a major life event such as the birth of a child, a marriage, or death of a loved one. Example frameworks are expected to provide an interactive experience, such as by prompting users for content, that solicits a variety of content exploring a shared context, such as the death of a loved one. Specifically, embodiments may solicit various types of content, like images, audio, text, and video. The framework may take as input a data structure within which these different types of content may be analyzed and relationships between that content determined, among other aspects. An example data structure may be a nodal data structure, like a graph, which may encode relationships between different nodes as edges, and the different nodes may correspond to different content items solicited from a user.

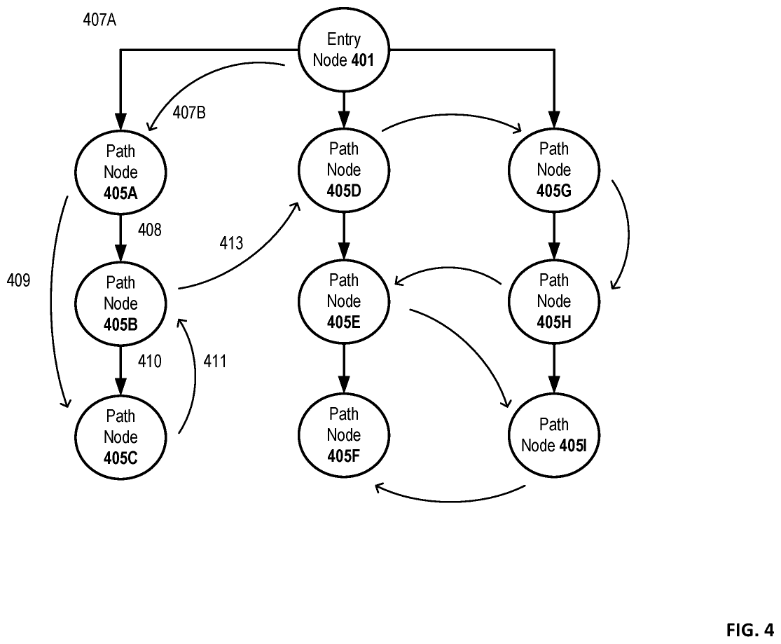

FIG. 4 illustrates an example nodal data structure by which the present techniques may be implemented. An entry point node 401 may be associated with the following information components: a unique identifier of the content path, a title of the content path, a description of the relation (e.g., edges) of the entry point node with other nodes, and one or more content items. In some examples, edges may be described by human readable text, such as by descriptions which may relate the entry point node to the other nodes. Other nodes in the graph 405 may include one or more edges, and each node may include a unique identifier of the node, a description of the node, and description of the relation (e.g., edges) of the node with other nodes, and one or more content items. In various examples, the edges may be directional and point from one node to another, in a path-like sequence.

In some examples, an edge may be associated with multiple parameters (e.g., edge 407 may store parameters corresponding to an edge 407A and an edge 407B, which may correspond to different graphs). For example, an edge may indicate relatedness, temporality, or whether it is resident to a content path, among other parameters. In some examples, the different edge parameters may indicate edges of different sub-graphs, such as different sequences by which nodes may be ordered. For example, in the context of death of a loved one, a user may upload a number of items of content that correspond to nodes descriptive of the loved one's service in the military (e.g., path nodes 405A-C), and an entry node may include an edge 407A pointing to a first node corresponding to that content (e.g., having a shared sub-context).

In many cases, a user may not select such items in temporal order, so additional edges, like edges 409 and 411 (e.g., as needed) may be formed among those nodes to indicate temporal sequencing (e.g., 405A, 405C, 405B), such as in addition to edges (e.g., 407A, 408, 410) which may indicate the order in which the user selected the content items (and where these edges are consistent with temporality, e.g., 407A, an edge parameter 407B corresponding to temporality may be updated). The user may also upload a number of other content items, such as of life events not related to military service, which may individually occur before, after, or during different points of the military career. These content items may also be represented by nodes (e.g., 405D-F), and the entry node may also point to a first node corresponding to that content (e.g., having a different shared sub-context). Edges and edge parameters for these nodes may similarly be generated among these nodes to indicate temporality. Edges may then be formed between nodes across the different sub-contexts (e.g., 413), such as to indicate cross-context temporality. Thus, for example, the order in which the different items of content were uploaded may correspond to one graph and the temporal order among the different items of content may correspond to another graph (or graphs, e.g., the temporal order within each sub-context may also be identified), and other parameters may be indicative of other paths, like a determined ordering based on a weighting of edge parameters. Entry to one of the graphs (e.g., like a given path through the nodes) may be enumerated by an edge description provided in relation to the entry node.

Accordingly, a variety of different sub-contexts for which content is solicited from a user may each correspond to a different branch of a tree-like data structure having a single entry point 401 which links each sub-context. In some examples, an edge may be formed between two nodes within a sub-context or across a sub-context based on a score output by a model, and the scores may be iteratively computed to adjust the edges. In some examples, a plurality of nodes may be created as children of a parent node, such as in response to detecting a plurality of people within an image or in response to a number of people or subject being described in relation to a content item.

In some examples, nodes may include a path action parameter, like a description of the action taken (or to be taken) when a user interacts with the path node. For example, after a user selects a framework and provides some initial information or content corresponding to the entry node 401, the system may generate a path node 405A corresponding to a first sub-context for the user to explore, and the path parameter may include a description of the sub-context. In some examples, a plurality of nodes (e.g., 405A, 405D, 405G or more) corresponding to different potential sub-contexts may be generated, and the path parameter may describe the different sub-contexts to the user (e.g., such that the user may select a given sub-context to explore). Examples of path action parameters may be a prompt, like a question, or statement, to solicit content from the user. For example, the user may elect to explore a path action parameter corresponding to path node 405G and later 405A or 405D, or elect not to explore some of those nodes based on their path action parameters. After engaging with path node 405G, the system may determine a path action parameter for a next node in that path, such as path node 405H, or a plurality of path action parameters from which the user may select to explore for path node 405H. For example, the system may process the content provided in association with path node 405G (and that provided in association with entry node 401) to determine a path action parameter or set thereof from which the user my elect to explore for path node 405H. After engaging with path node 405H, a path action parameter for a node 405I may be determined based on the content provided in association with nodes 401, 405G, and 405H. In some examples, path action parameters are determined using a NLP model, like one described herein, which may take as input descriptions of the previous nodes to generate an output prompt or statement, which may be selected as the path action parameter.

In some examples, the framework may be trained to select nodes, and order nodes, from which descriptions are to be obtained to determine a path action parameter. For example, the model may be trained to weight selection and ordering criteria based on relatedness of descriptions, such as across contexts or within a context, depth of a sub-context relative to other sub-contexts, distance from an entry point along a path through different graphs, or other parameters. Thus, for example, after engaging with one sub-context to generate a number of content nodes, the framework may cause the system to select nodes from outside of the sub-context, or closer to the entry point along a graph, and generate path actions for nodes that correspond to other sub-contexts for exploration. Additionally, training of frameworks may learn that certain sub-contexts are more popular with users (e.g., commonly explored further than others) to permit a deeper exploration within those sub-contexts relative to others, or to refine that sub-context into multiple sub-contexts (e.g., by adjusting a threshold distance between descriptions with the sub-context to balance depth of different sub-contexts).

The above and other operations may be performed iteratively as the user engages with an instance of a framework to provide content onto the content path creation system, such as to adjust sub-contexts and generate path action parameters. In some examples, a framework selected by a user may include a number of pre-defined path action parameters, such as for different potential sub-contexts users often cover within the context of the framework or within a specific sub-context. The pre-defined path action parameters may in some cases be partially defined, with the remaining information determined as described above based on user engagement. For example, a framework for creating a content path corresponding to a scientific experiment may have some defined portions of prompts, such as to solicit a specific type of information (e.g., observations) but which are determined at run time to prompt for specific observations (e.g., “Did the solution change color?”) based on prior node content within a sub-context (e.g., a node description indicating a step of titration). Thus, for example, some frameworks may be more open ended than others but each may solicit content in a conversational manner specific to the experience of the user.

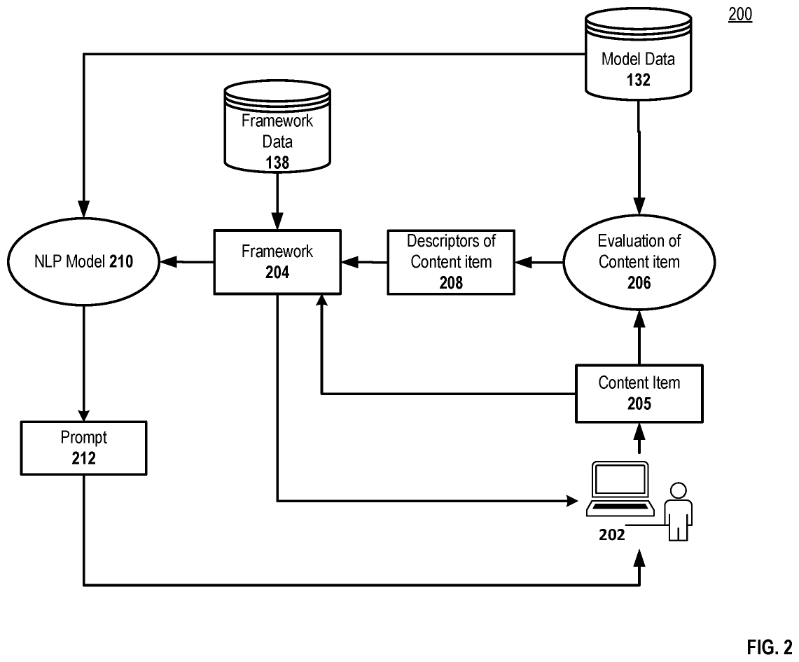

FIG. 2 is an example environment 200 for content path creation using a content path system within which the present techniques may be implemented in accordance with some example embodiments. In some embodiments, a user computing device 202 may be presented with a set of frameworks, like different contexts, that the user may select from based on the experience the user wishes to share. For example, the user may select a framework 204, like “project”, deemed contextually relevant to a science experiment which the user wishes to document or share with others. In response to selection of a framework, framework data 138 corresponding to the framework may be obtained to initialize a framework instance 204 for the user. Initialization of the framework may comprise obtaining via the user computing device 202 from the user a general description for the framework, like a title and description of what the content path is about. In some examples, the user may be presented with a number of predetermined options for a title or description, like “science experiment,” “home improvement,” or the like, with a user optionally be able to enter their own description to a prompt like “What project are you working on?”. In some examples, the user may upload or generate content 205 and the system may determine a description. For example, the user may upload a project plan, project report, or in other examples, a eulogy or poem or images or video. Embodiments may analyze the content, such as with one or more models stored in model data 132 to determine a description for an instance of the selected framework.

Once a framework 204 is initialized, the framework may provide data to a NLP model 210, such as to determine one or more prompts 212 for soliciting relevant content from the user. Initially, for example, the framework 204 may provide the description of the framework (e.g., context) and framework data, like potential sub-contexts or wholly or partially pre-defined prompts corresponding to different sub-contexts to the NLP model 210. The NLP model 210, in turn, may output one or more prompts 212 or statements for soliciting content from the user, where those prompts or statements are relevant to the context indicated or selected by the user for the content path. In some examples, the framework 204 may initially bypass the NLP model 210 to provide one or more predetermined prompts to the user computing device 202.

The user may utilize the user device 202 to elect to respond to a prompt 212, such as by providing a content item 205 (or content items) like one or more of text, image, audio, or video data to the system in relation to the prompt. The received content item 205 may be stored in association with the prompt 212 within a data structure of the framework 204. Additionally, the system may process the content item 205 to determine information about the content item. For example, the system may determine descriptors of the content item, like what is depicted in an image, in different portions of a video, discussed or heard in audio, or described in a natural language text. The system may evaluate 206 different content items in different ways, such as based on the type of content item. For example, based on a type of content item, one or more models may be selected from the model data 132 to process the content item. The output of the processing may comprise descriptors 208, or in some cases, a description of the content item. In some examples, a user may be requested to indicate whether the descriptors or description is accurate, and may optionally modify the descriptors or description. The descriptors may be associated with the content item in the data structure of the framework. In some examples, multiple content items may be provided in response to a prompt or a content item may be segmented in a number of content items (e.g., different segments of a video, image, audio or text). Embodiments may analyze the different segments and associated each segment with its respective descriptors and may form an association from each of the segments to the original content item. The original content item may be associated with the descriptors of each of the segments.

The framework 204 may determine associations between different ones of the content items based on the descriptors and other data, like timestamps, EXIF data, etc., associated with the content items. In some examples, indications of similar types of information may be indicated by the user. For example, within a user interface corresponding to the framework 204, a user may indicate temporality of content items that cannot be inferred by the system. In some examples, a prompt may infer temporality between content items, e.g., “Did [description of content item] happen after [description of a different content item]?” or a user may indicate temporality, such as by organizing one or more content items on a timeline.

The framework 204 may determine associations between content items based on similarity of descriptors, such as whether two content items correspond to a same sub-context, or are otherwise related. For example, if persons A and B of a family on vacation went on a horseback ride on the beach and went whale watching but persons C and D went shopping instead of on the horseback ride, a sub-context may correspond to each different activity or what persons A-D did together (everyone went whale watching) and what other grouping of people did together.

The framework 204 may process the data structure based on properties associated with the different one of the content items, such as based on scores indicative of similarly between descriptors, temporal order or scores thereof, etc., to select descriptions or descriptors corresponding to one or more content items. The data structure may include information indicative of one or more graphs by which different content items are related (e.g., their associations) and strengths of those associations (e.g., based on respective scores) which may be updated prior to selection of the descriptions. In some examples, the framework 204 may adjust weights or biases of a model for selecting content items based on the associations, such as by iteratively updating weights or biases of the model based on the content items within the framework. The adjustments to the weights or biases of the framework model may cause a system to select the description for the framework or descriptions of content items corresponding to different sub-contexts that are not as fully explored as others or new (or pre-defined) sub-contexts or pre-defined (or partially pre-defined) prompts of the framework that are not yet explored in content items 205 provided to the system by the user. The descriptions (or descriptors), or sub-contexts, or prompts may be provided, e.g., in ordered relation based on their scores or other selection criteria, to the NLP model 210 for processing to determine a new prompt or set of new prompts 212 for the user to elect to engage with. The NLP model 210 may output, for example, a question or statement that prompts 212 the user to provide new content onto the platform, such as content based on the subset of selected textual information input into the NLP model. The NLP model 201 may implement an attention mechanism that biases output text (e.g., a prompt) to relate back to the inputs. In some examples, outputs of the NLP model 210 may be evaluated against the input information to select an output comprising at least one new potential descriptor for soliciting a new content item from the user or information about a content item (or multiple content items) within the data structure of the framework in a conversational manner. In other words, the prompt 212 aims to obtain some amount of new detail within a shared context from the user, such as by shifting between sub-contexts of the shared context to solicit new content that was not previously provided (e.g., to maintain a focus of the content within the context of the framework).

As the user responds to prompts 212 with content items 205, a user interface may display the different content items and proposed paths through the content items, such as based on the associations determined by the framework for the content items within the data structure. In some examples, information encoded within the data structure may be described to the user, such as with textual descriptions or organization of the content items or subsets of the content items within an interactive user interface. The user may elect to switch views between different identified paths (e.g., based on one or more sub-graphs of content items) through the content items and modify the paths, such as by reorganizing the different content items on a timeline (e.g., indicative of temporality). The user may form groups of content items, such as within a view pane, to create a node along a path that includes two or more content items. Properties of an association between the two or more content items may be defined to indicate their relative position and how they are displayed, such that navigation to one of the content items along a path causes the group of content items to be displayed. The user may define properties of transitions between content items or groupings of content items along the path, such as how long to display a content item before transitioning to a next content item on the path and the like. Some embodiments may train one or more style transfer models to assist users in augmenting or refining the display of content within a content path. For example, an organization of one or more content items and design elements (e.g., background, text, boarder colors; style of text; positional information/frames; presentation styles for a given set of content items, transitions between content items, or how and when to display one or more content items individually or collectively, etc.) configured by a user for presentation may be analyzed relative to organization and design elements configured by other users. Explicit ratings or rankings or implement feedback from users based on engagement with content paths may be processed to score organization and design element attributes of content items within the content paths. Training of a style transfer model may learn organizational and design elements attributes by which content within highly ranked or engaging content paths is presented. In another example, training of a style transfer model may use content paths that a user has ranked highly (e.g., user preference for certain styles of content paths), content paths having a similar context, or a selection of a combination of content paths based on rank according to a combination (e.g., like a weighted combination) of the above criteria. In turn, the style transfer model may determine modifications to existing organizational and design element attributes, or determine organizational and design elements attributes, for the presentation of content items within a content path. In other words, a user may elect to process one or more portions of a content path with the style transfer model to automatically configure one or more organizational and design element attributes for the presentation of content within the one or more portions of the content path. The above examples should not be construed as limiting, as other examples are described herein and even more examples should be readily apparent to the reader in view of the techniques described herein.

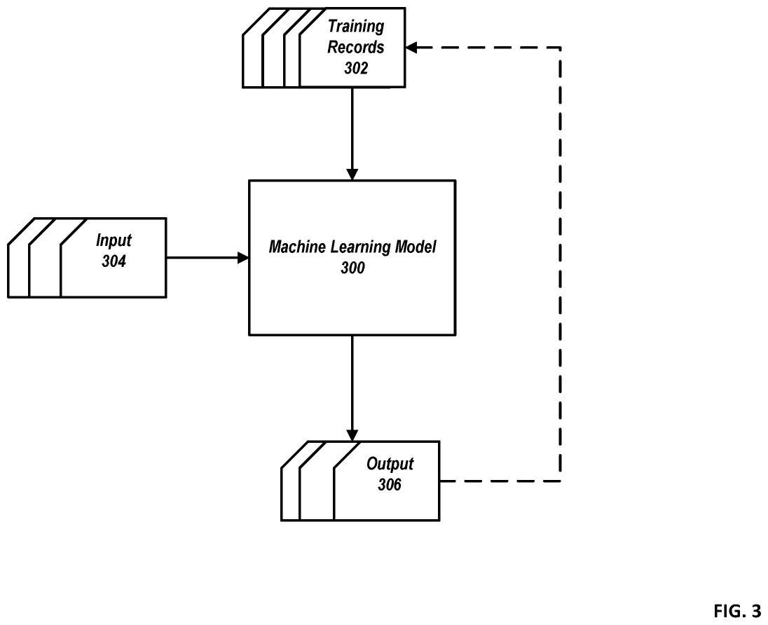

Models like those described above (and elsewhere in the present specification) may be machine learning models that are trained and executed by one or more systems or subsystems like those depicted in FIG. 1 to process inputs and generate outputs, some examples of which include those described above, and some examples of which include those described under other headings within the present specification. An example of a machine learning model consistent with the present techniques is described with respect to FIG. 3. A machine learning model 302 may take one or more inputs and generate one or more outputs. Examples of a machine learning model 302 may include a neural network or other machine learning model described herein, may take inputs 304 (e.g., input data like that described above) and provide outputs 306 (e.g., output data like that described above) based on the inputs and parameter values of the model. For example, the model 302 may be fed an input or set of inputs 304 for processing a content item or outputs determined by other models and provide an output or set of outputs 306. In some cases, outputs 306 may be fed back to machine learning model 302 as input to train machine learning model 302 (e.g., alone or in conjunction with indications of the performance of outputs 306, thresholds associated with the inputs, or with other feedback information). In another use case, machine learning model 302 may update its configurations (e.g., weights, biases, or other parameters) based on its assessment of a prediction or instructions (e.g., outputs 306) against feedback information (e.g., scores, text, or with other feedback information) or outputs of other models (e.g., scores, descriptors, natural language texts, etc.). In another use case, such as where machine learning model 302 is a neural network, connection weights may be adjusted to reconcile differences between the neural network's prediction or instructions and the feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 302 may be trained to generate better predictions or instructions.

In some embodiments, the machine learning model 302 may include an artificial neural network. In such embodiments, machine learning model 302 may include an input layer and one or more hidden layers. Each neural unit of the machine learning model may be connected with one or more other neural units of the machine learning model 302. Such connections can be enforcing or inhibitory in their effect on the activation state of connected neural units. Each individual neural unit may have a summation function which combines the values of one or more of its inputs together. Each connection (or the neural unit itself) may have a threshold function that a signal must surpass before it propagates to other neural units. The machine learning model 302 may be self-learning or trained, rather than explicitly programmed, and may perform significantly better in certain areas of problem solving, as compared to computer programs that do not use machine learning. During training, an output layer of the machine learning model 302 may correspond to a classification, and an input known to correspond to that classification may be input into an input layer of machine learning model during training. During testing, an input without a known classification may be input into the input layer, and a determined classification may be output. In some examples, a classification may be an indication of whether one or more objects are depicted within an image or indications of other similar images, and objects or other images may be associated with labels, like descriptors of what is depicted, like what object is depicted or what scene similar images depict. In some examples, a classification may be words detected in speech, and which participant, like in a dialogue, the words were spoken by, or what sounds were otherwise detected in audio which may optionally include speech. In some examples, a classification may be an indication of a theme detected in a natural language text, which in some examples may be a summary of the natural language text or descriptors of the natural language text.

In some embodiments, a machine learning model 302 may be a non-linear model or semi-supervised learning model that can perform classification or regression. For example, the machine learning model 302 may be a general-purpose semi-supervised learning algorithm that a system uses for both classification and regression tasks. In some embodiments, a machine learning model 302 may be implemented as a decision tree or as an ensemble model (e.g., using random forest, bagging, adaptive booster, gradient boost, XGBoost, etc.). In some embodiments, a machine learning model 302 may incorporate one or more linear models by which one or more features are pre-processed or outputs are post-processed, and training of the model may comprise training with or without pre or post-processing by such models.

In some embodiments, a machine learning model 302 implements learning via one or more neural networks, which in some cases may include multiple parallel networks, like multiple heads of a multiheaded attention transformer. Examples of such models may include encoders (which in some examples may reduce dimensionality of high-dimensional data (e.g., input texts), like an embedding of a word), decoders, and multiple neural network layers. In some examples, an encoder may determine an encoded representation for each word in an input sequence of text that captures the meaning and position of each word. In some examples, such as in the case of descriptors, descriptors may be ordered and that order adjusted based on a priority, removed, or added as inputs at different stages of content path creation, such as to cause the model to favor depth or breadth in outputs, such as to explore a different potential area of content. The encoders and decoders may incorporate an attention mechanism, like self-attention layers, which may assign attention scores for each word. Decoders may include, in addition to a self-attention layer, an encoder-decoder attention layer that additionally receives input from encoder output. Some example embodiments may include stacks of 3 or more, like 6, encoders and decoders in respective stacks that sequentially pass their outputs up the respective stacks, with the encoder-decoder attention layer of respective decoders receiving output from the encoder stack. Output of the decoder (e.g., like a last decoder in a stack) may generate scores, with a score value for each unique word in a target dictionary, at each position, such as in a sentence. The score values may indicate the likelihood of occurrence for each word in the dictionary in that position of the sentence, and words of the sentence may be selected based on their likelihood of occurrence at each position. In turn, the selected words may be output in sequence, like an output sentence.

Examples of machine learning models may include multiple models. For example, a clustering model may cluster representations (e.g., vectors indicative of images, text, descriptors, etc.) by distance in training (or output) data. In some cases, rankings or other classification of a (or a plurality of) content represented by vectors within a cluster may indicate information about other content items represented by vectors within, or which are assigned to the cluster. For example, a clustering model (e.g., K-means, DB SCAN (density-based spatial clustering), or a variety of other unsupervised machine learning models used for clustering) may take as input a vector and determine whether it belongs (e.g., based on a threshold distance) to one or more other clusters of other vectors that have been previously identified and labeled during training.

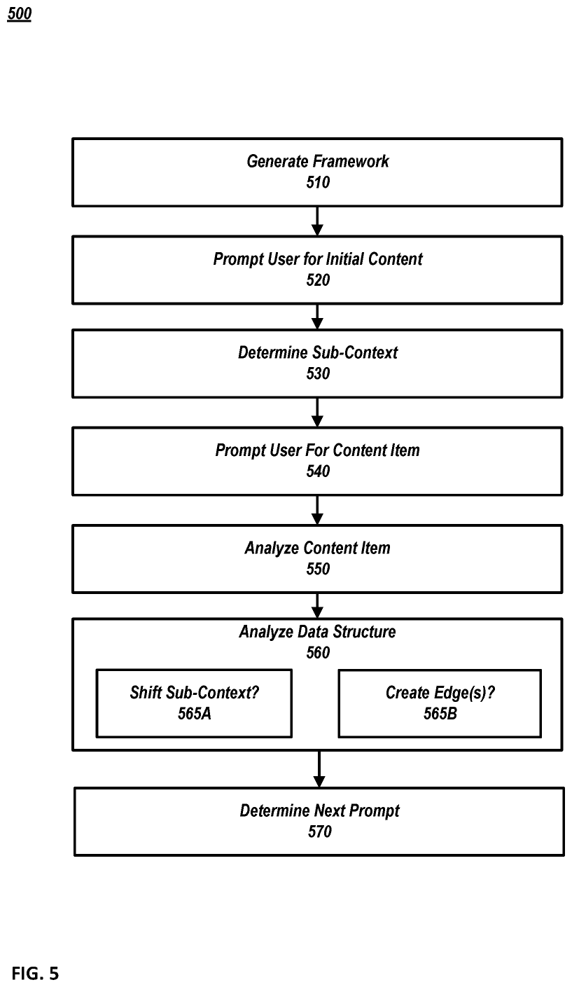

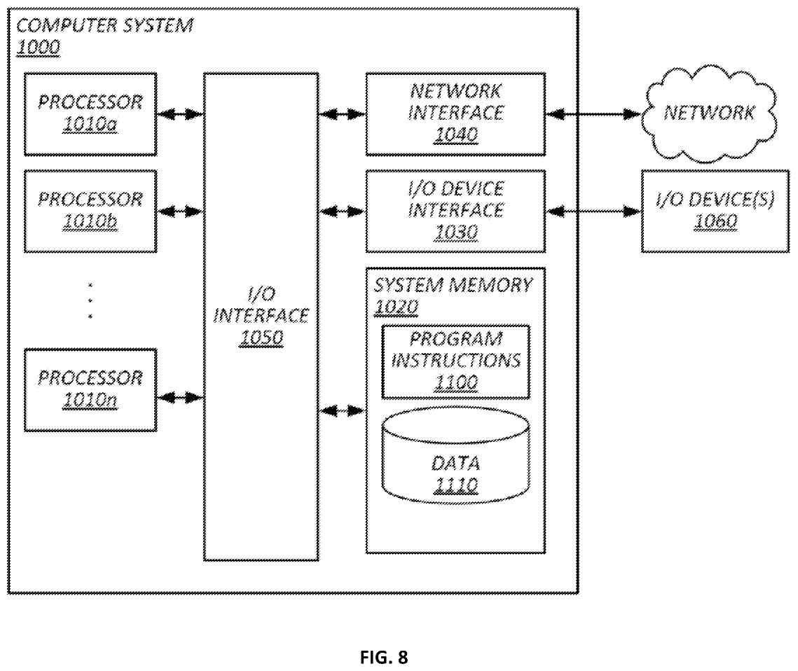

FIG. 5 is an example process 500 of content path creation by which the present techniques may be implemented. Embodiments of the process may be implemented by a content path system like that described with reference to FIG. 1, such as upon a computing device like that described with reference to FIG. 8. Embodiments may perform some or all of the steps of the process 500, or other functions descripted herein, and may perform steps in a different order than illustrated.

In a step 510, the process may include generating one or more frameworks, which may correspond to different contexts, from which users may select a framework to create a content path (e.g., consistent with the context). Some embodiments of the process may generate a framework based on one or more existing content paths, which in some examples may be seed content paths, having a shared context. In some examples, the process may include determining whether one or more content paths share a context. For example, content items within a content path may be analyzed to obtain textual content (e.g., native text content or descriptors of content items, where descriptors may be determined by classification techniques described herein) which may be processed by a NLP model trained to determine whether content paths, or portions thereof, share a context or have a similar context. The above steps may be performed iteratively as content paths are created, such as to capture different ways in which users explore a context. The context need not be specific, rather in many examples it may be preferably generic. Examples contexts which may correspond to some example frameworks might include, but are not limited to, “an experience,” “life milestone,” “legacy preservation,” “project,” and the like. The generated framework may be a trained, or in-training model, that is trained to infer and explore, as users engage with the framework to create a content path, sub-contexts with more specificity. In some examples, such as those using in-training models for frameworks, the model may undergo refinement as the user engages with the framework, such as by the user selecting or providing content items for the content path while interacting with the framework. The framework may be trained to balance between depth and breadth coverage (e.g., of different sub-contexts) within a context which the user wishes to explore with a content path, and hierarchically organize content provided by a user and determine a path through the content (which a user may adjust).

In step 520, such as upon or after user selection of a framework (e.g., generated as described above or elsewhere herein), the process may prompt the user for initial content. In some examples, the initial content corresponds to an entry node of a tree-like data structure or graph. The prompt may be dependent on the selected framework. For example, selection of a “life milestone” may cause the system to prompt the user to provide content indicative of the milestone, e.g., “What milestone is being celebrated?” or for a selection of “project” the system may prompt the user to provide content indicative of the project, e.g., “What are you creating?”. The user may respond to the prompts in a variety of ways. For example, a user may provide a textual description (e.g., “Celebrating our 30^{th} wedding anniversary” or “Remodeling the kitchen”, respectively) or select a content item which the system may analyze and request the user to confirm a determination made by the system, supplement that determination (e.g., with additional description), or provide their own description. As an example, a user may select “project” and upload a picture of an automobile, which the system may analyze to determine a classification of “automobile” and optionally a type, make or other details pertaining to the automobile. A natural language processing model may receive the classification (or other determined descriptors of the image) and framework data based on the classification (e.g., instances of automobiles within content paths of users who selected the project framework, which may include various vehicle restoration or modification projects) and output possible descriptions of the project based on the inputs, which may be formulated as a question, (e.g., “Are you restoring a Ford Mustang?” or “Are you modifying your Ford Mustang?”) in some examples. Additionally, in step 520, embodiments of the process may store an entry node of a content path, the contents of the entry node being based on the initial content and the selected framework (e.g., Project: Restoration of a 1967 Mustang).

In step 530, embodiments of the process may determine a first sub-context for exploration within the content path. In some embodiments, a sub-context may be determined by the framework based on data structures of other content paths of users, such as based on how those other content paths are hierarchically structured. For example, a framework model may score and rank, for a given context, associated sub-contexts based on frequency of appearance and order of appearance within content paths created by users. Continuing with the automobile restoration example, content paths relating to restoration of automobiles may frequently explore a prominence or history of the make and model of automobile prior to exploring mechanical or exterior or interior work performed by the user to restore the automobile. Embodiments may contemplate exploration both in the actions of a user when selecting content for a content path (e.g., what sub-contexts users often explore first) and also ordering of content items for presentation to other users viewing the content path created by the user. For example, the framework model may identify non-linear (e.g., non-chronological) differences between creation and presentation phases for content paths, which is expected to improve solicitation of content while maintaining coherent hierarchical organization. Specifically, within some contexts, the framework model may determine that users frequently explore a first sub-context prior to a second sub-context during content path creation even if content relevant to the second sub-context is presented prior to content relevant to the first sub-context within the content path.

In step 540, embodiments of the process may prompt a user for a content item related to the first sub-context. Examples of a prompt may be a question or statement that is determined by an NLP model for soliciting content relevant to the sub-context from the user. In some embodiments, the system may generate a path node within the data structure that corresponds to the first sub-context for the user to explore. Embodiments may create an edge between the entry node and the path node, the edge being associated with a path parameter based on a description or characteristics of the first sub-context. Examples of path action parameters may be a prompt, like a question, or statement, to solicit content from the user. Embodiments of the NLP model may determine the prompt based on the context/entry node data (e.g., the initial content) and the sub-context. Continuing with the above example, a prompt determined by the NLP model might be a question like “Who previously owned the 1967 Mustang?” or “How did you come into possession of your 1967 Mustang?” that accounts for the context (e.g., restoration of a 1967 Mustang) and the first sub-context (e.g., prominence). In turn, the user may respond with a content item, such as prose (e.g., within a text field) or by selection of a content item (e.g., uploaded to the system from their user device).

In step 550, embodiments of the process analyze the content item received in response to the prompt. Examples of analysis performed may include one or more operations like those described with reference to step 520, such as to determine descriptors of the content item, which may be based on image classification results, analysis of textual content, etc., and those descriptors may be stored as path node content in association with the content item.

In step 560, embodiments of the process analyze the data structure to determine a next input to the NLP model. Some embodiments may determine, based on the analysis, whether to shift to a different sub-context 565A or create an edge between two nodes 565B. The framework model may analyze the data structure and determine to shift (or not to shift) to a different sub-context 565A based on the depth of path nodes in the current (e.g., first) sub-context being explored by the user in the content path and depths of path nodes (e.g., with a same or similar sub-context) in content paths of other users. For example, if the depth of path nodes in the current sub-context is less (or greater) than a measure of central tendency than the depths in the content paths of other users, the framework model may determine a score indicative of the difference of depth. The framework model may analyze the data of the path nodes in the current sub-context within the data structure relative to the data of the path nodes in content paths of other users and determine to shift (or not to shift) to a different sub-context 565A based on the amount of content explored by the user in the content path for the current sub-context relative that in the content paths of other users. For example, the framework model may score an amount of descriptors determined for content of the path nodes in the current sub-context relative to amounts of descriptors determined for path nodes within the same or similar sub-context in other content paths. In another examples, the framework model may score a coverage of the sub-context by the user for the content path based on the descriptors, e.g., based on a frequency of their appearance as descriptors for path nodes within the same or similar sub-context in other content paths In some embodiments, the framework model may score user fatigue for exploration of the sub-context based on the content of the path nodes. For example, an amount of descriptors by which sequentially provided content for path nodes in a sub-context is characterized by analysis of the content may be scored based on a sliding window measure of central tendency (e.g., is a recent sliding window of content selections by the user for the sub-context providing more, less or about the same detail as prior sliding window of content selections). The above sliding window approach may similarly be applied to score amounts of new descriptors (e.g., not previously identified for content selected by the user) in sequentially provided content for path nodes, such as to detect when the user is providing repetitious content. One or more of the above scores, or other similar scoring metrics, may be determined by the framework model to output a determination to shift (or not to shift) to a different sub-context. For example, the framework model may be trained to balance between depth (how many path nodes a user explores for a sub-context) and breadth (how many sub-contexts are explored) based on how users interact with the framework relative to other users (e.g., which may exhibit similar behaviors for exploration). Some users, for example, may provide less content with respect to each prompt, but that content may be characterized by different descriptors, and thus the framework model may determine not to shift contexts even if the depth of path nodes for a sub-context exceeds a measure of central tendency across all users. Conversely, for users that provide one or more content items that offer a higher degree of semantic coverage (e.g., more descriptors) for a sub-context in response to each prompt, the framework model may determine to shift contexts even if the depth of path nodes for the sub-context does not exceed a measure of central tendency across all users. In some examples, training of the framework model may learn weights and biases of a model, like a neural network, based on nodes and node content of content paths created by users to output a determination of when to cause a sub-context shift as a user engages with the framework to create a content path.

Additionally, in step 565B, some embodiments may determine to create an edge between two nodes 565B based on an analysis of node data of the nodes within the data structure. Created edges may correspond to a path through the nodes to be followed during their presentation or indicate other properties or relationships between the nodes. For example, the framework model may determine, based on descriptors, a temporal order of nodes that differs from the order in which users selected content items for nodes and create one or more edges to indicate an inferred temporal order of the nodes. Within a sub-context, for example, a user may select one or more content items out of temporal order of their occurrence and the framework model may infer a temporal order based on the contents of the content items (e.g., based on the descriptors). In turn, the framework model may determine based on the descriptors associated with the respective nodes whether to create an edge between one or more nodes in a sequence of path nodes to indicate temporal order. In some examples, users may indicate temporal order between some pairs of nodes based on user manipulations of order among content items within a content path. However, in some examples, such manipulations may not place the nodes in temporal order. Additionally, embodiments of the framework model may determine edges based on similar of nodes based on their descriptors. In some examples, one or more edges may cross sub-contexts, such as being formed between a path node within a first sub-context and another path node within a second sub-context. As an example, the framework mode may determine to create an edge between nodes across sub-contexts based on temporal order or whether those nodes have one or more related descriptors for which edges are created (e.g., two path nodes in different sub-contexts each have descriptors corresponding to a same individual). Thus, for example, some nodes may have multiple edges, such as based on order of creation, temporal order, order of presentation, or relatedness to other nodes (e.g., based on relationships of descriptors).

In step 570, embodiments of the process determine a next input to the NLP model for generating a prompt for a content item from the user (e.g., for a new path node). The next input may be determined from the data structure based on the results of one or more operations described above. For example, in response to a determination to shift sub-context, embodiments of the framework model may determine a new sub-context, e.g., by performing operations like those described with reference to step 530 after excluding existing sub-contexts (or similar sub-contexts) already explored within the content path. In another example, such as in examples where a user has already explored a set of sub-contexts frequently explored by other users within a shared or similar context, the process may present a set of potential sub-contexts (e.g., less frequently explored sub-contexts) from which the user may elect to explore, provide a field for the user to specify a new sub-context which the user desires to explore, or display existing sub-contexts within the content path from which the user may select for further exploration. Alternatively, a determination may be made to not shift sub-context. In either case, embodiments may determine a next input to the NLP model based on the current or shifted (e.g., a target) sub-context and the data structure. For example, the framework model may analyze the path nodes and edges of path nodes within the target sub-context. In some cases, such as where the target sub-context is a new sub-context, the input to the NLP model may be descriptors of the entry node and the new sub-context. In other examples, such as where the target sub-context is a current or existing (but to which a shift is made) sub-context (e.g., some amount of exploration has occurred in either case), the framework model may determine a set of nodes (e.g., within the sub-context) from which to select descriptors for input to the NLP model based on the edges between nodes within the data structure of the content path. In various embodiments, such as in examples where the NLP model implements an attention mechanism, the framework model may determine an ordering of the nodes from which one or more descriptors are selected. Order among the nodes may be determined by the framework model based on the edges between nodes, such as to temporally order descriptors selected from the nodes, thereby causing the NLP model to generate a prompt that is temporally consistent with the user's exploration of the sub-context. In some examples, the framework model may select one or more descriptors from nodes across sub-contexts based on their edges to nodes within the set of nodes, such as to incorporate one or more such descriptors from those related nodes as ordered input. Embodiments may order these descriptors within an input string based on temporal order, or the relation to other descriptors in their respective temporal order, or a weighted combination of the respective positions. In some examples, a weighted combination may further be based on descriptors of ordered content selections (or presentation order adjustments) made by the user (e.g., to permit the user to explore a sub-context with attention to how the user is selecting or ordering content in ways other than based on their temporal order). For example, a user may be selecting or adjusting a presentation order of poems within a sub-context based on their structure or preference for the poems without regard to when they were written (or temporal order of events described by the poems). In some examples, the framework model filters descriptors from inputs to the NLP model which have already been explored by the user to bias generation of prompts corresponding to other semantic areas within the target sub-context for exploration. In some embodiments, the framework model is trained, such as based on the data structures of completed content paths, which comprise edges having properties like those described above, to select a set of nodes and descriptors predicted to most efficiently guide a user to cover sub-context within a content path. Thus, for example, the framework model may learn to determine selections of sets of nodes, descriptors from those nodes, and orderings for input to the NLP model that are predicted to minimize a number of additional prompts that will be needed to cover a semantic space of a sub-context of a content path being explored by the user. Similar to operations in step 540, inputs, like an ordered string of descriptors, may be fed into an NLP model, and the NLP model may comprise an attention mechanism that outputs prompts that are, at least in part, responsive to order of input of the descriptors such that users are prompted to select content items that further explore (e.g., new areas of) the semantic space of a sub-context.

Embodiments of the process 500 may iteratively perform one or more steps, such as steps 540-570, to prompt a user for content, analyze obtained content, and determine a next prompt for requesting additional content from the user to explore one or more sub-contexts having a shared context within the framework. Use cases are expected to improve efficiency of exploration and thus reduce user fatigue by engaging with users in a conversational manner with prompts that balance depth and breadth exploration of sub-context within content paths (and determine sub-contexts for users to explore). Additionally, embodiments of steps of the process 500 may incorporate other or additional operations described throughout this document without departing from the scope of the process.

Some embodiments may permit multiple users to engage in a process similar to that described above with reference to FIG. 5 to collaborate on creation of a content path, and in some cases, concurrently. For example, one or more other users using a respective user device 104B-n may, in addition to a user of user device 104A, collaborate to create a content path. In turn, one or more of the steps in process 500 may be executed for a second user that is collaborating with a first user. For example, a first user may provide some initial content as described with reference to steps 510-530 and, optionally, some subsequent content as described with reference to steps 540-570, and a second user may also provide subsequent content consistent with operations described with reference to steps 540-570. While examples are described in reference to a first user and a second user, 5, 10, or more users may asynchronously or concurrently collaborate on creation of a content path with operations like those described in steps 540-570 being executed for each of the users collaborating on the content path.

The first user may specify one or more other users (e.g., a second user) that are permitted access to the content path to collaboratively create the content path. For example, the first user may invite another user of the content path system to collaborate on the content path or invite a user to create an account on the content path system to collaborate on the content path. In some examples, the first user may invite a group of users or otherwise invite a plurality of users to collaborate on the content path. Permissions of the content path system may be updated to grant users indicated by the first user access and privileges to modify and add content to the content path.

The second user may accept an invite to collaborate with the first user (and in some cases, one or more additional users which may have privileges similar to the second user, e.g., third, fourth, fifth, etc. users) and access the content path, which may be in a given stage of completion. After accessing the content path, the second user, in some examples, may be provided with options within a user interface to select a content path node (or content corresponding to one or more content path nodes), select a point (e.g., within a timeline) during presentation of content within the content path (which may correspond to one or more content path nodes), or elect to continue where the first user left off (whether at the end of presentation of content or providing content for a sub-context, such as via content path nodes) to modify content within or provide additional content for the content path. The collaborative process may, in some examples, iterate through steps similar to 540-570 for the second user, with the first user also iterating through steps similar to 540-570, at the same or different times. Some iterations may replay the same or similar prompts to those presented to one or more users, such as where at least one user already provided content in relation to a sub-context but another user elects to participate in the content selection process for the sub-context. For example, a second user may provide additional content in response to prompts that are the same or similar to those that a first user interacted with to add an additional perspective on a similar experience or subject matter. As an example, if a content path corresponds to an experience, like a vacation, that both users took together, the second user may provide content that compliments that already provided by the first user.

In some embodiments, when a user modifies content or adds additional content in association with an existing path node within the content path, the content path system may generate a new content path node. The new content path node, in some examples, may be associated with the existing content path node and take on the same relationships to other nodes within the content path as the existing content path node when the new content path node is presented instead of the existing content path node. In some examples, a new content path node may be marked or flagged as associated with the user that created it. In some example embodiments, such as in association with one or more of steps 540-570, the process may generate a collaborative path node. A collaborative path node may be based on a set of content path nodes (e.g., the new and existing content path nodes in the above example) on which multiple users collaborated by each modifying or supplementing content for a same path node (e.g., location thereof) within a content path. Generation of a collaborative path node based on the contributions of respective users may reduce conflicts during the collaborative process. For example, after a user modifies or adds content and a new path node is created by that user in association with an existing path node that was created by another user (which be a set of path nodes created by respective users that corresponds to a single location within the content path), a collaborative path node may be generated based on a current state of the path nodes in the set created by the respective users.

In some embodiments, a user accessing a content path may toggle on/off one or more other users' contributions to a content path, and the content path system may analyze one or more portions of a content path based on a user selection of contributors. In some examples, the analysis may recompute a collaborative path node to include only content based on that provided by the selected users. If only one user is selected, presented content may be restricted to that provided or interacted with by the selected user (which may optionally include or omit modifications of content of other users performed by the selected user).

In some embodiments, a user may modify a collaborative path node, such as to organize or adjust the presentation of content or prune content from the collaborative path node. Conflict free replicated data types may be used to facilitate updates of state of the collaborative path node for different users concurrently accessing the collaborative path node or content path. For example, the content path system may analyze a portion of a content path which users modified or added content to and merge state to resolve conflicts, which may include transmitting information about changes in state of one or more content path nodes as a delta between prior and modified state. Modified states of a same content path node may be analyzed to determine a single output or merged state. Additionally, new content nodes and relationships formed between content nodes, like edges, may be communicated as deltas of content path to propagate state changes of the content data path data structure among concurrent user sessions.

### Time and Event Delayed Sharing

Time and event delayed sharing is expected to provide first play and re-play ability of content (e.g., within a content path or a portion of a content path) at different times, or over time, such as responsive to events, based on rules. In some examples, users may use specific rule sets, which may include one or more dynamic rules to trigger access to a content path or portion of a content path by one or more users responsive to events. In some embodiments, an event subsystem 120 determines whether to permit, or promote, access to a content path or portion thereof by one or more users in response to detected events.

By way of example, a user may create a content path that celebrates milestones of a child, grandchild, or other relation, where one or more of those milestones have not have yet occurred. For example, a great-grandmother may wish to create a content path for a great-grandchild (or even one or more yet to be born) that includes content relevant to milestones in the future that have not yet occurred (and which the great-grandmother may not be able to participate in). Example embodiments of an event subsystem 120 may detect events and determine to permit access to a content path or portion thereof related that event for one or more users. In some example use cases, user access may be granted responsive to rules governing permission to access content, and in some examples, the event subsystem 120 may determine to which users the rules apply. For example, a grandchild may add their child (e.g., when born, or later) as a user, or otherwise to be notified and permissioned to access content, and the event subsystem 120 may determine that that child is a great-grandchild of another user (e.g., the great-grandmother who created one or more content paths to celebrate future milestones of their great-grandchild), and when to provide the child access to a content path or a portion of a content path based on a rule set, which may include rules specific to granting access responsive to future life events. Dynamic rules may facilitate modification of content path content by the event subsystem 120, such as based on modification of name, gender, or other information that may not yet be known at the time of creation of the content path or the content by a user. In some examples, users may elect to apply one or more dynamic rules that determine modifications to content path content based on information inferred or determined by the event subsystem 120 at a later date. Additionally, some example rules may govern when access to a content path or portion thereof is granted to one or more users (which may or may not be known to the system at the time of rule configuration).

In some embodiments, the framework database 130 may include event data 140 by which rule sets and dynamic rules may be implemented based on events and other information. The event data 140 may include data from a plurality of sources, which may include information about historical events, and ingested data which may be indicative of current events. Additionally, the event data 140 may include data about different users of the content path system 102 and content paths of the content path system 102. For example, the event data 140 may include data about events, like anniversaries, birthdays, graduations, weddings, vacations, retirement, religious holidays, etc. of (or celebrated by) users, and data about events to which different ones of the content paths correspond, which may include one or more of the above events or other historical events or current events. The event subsystem 120, in some examples, may infer dates corresponding to one or more events like those described above from content of content paths, or may be explicitly provided with dates in some cases (e.g., during user registration or date provided during creation of content paths which may correspond to specific past, current, or future events).

In some embodiments, the event data 140 may comprise records corresponding to users of the content path system 102, and in some cases corresponding to people related to (e.g., referenced by) one or more users of the system. Record information for a person reference by a user of the system may be stored in association with the record of the user that referenced that person. In the case of that person later becoming a new user of the system, the new user may be prompted to confirm associations with one or more other users (and vice versa), and the confirmation of an association by both parties (e.g., the new user and an existing user) may cause the content path system 102 to establish record information corresponding to new user based on a portion of existing information known about the new user from other users. For example, if a partner in a marriage is an existing user and the other partner later becomes a new user, some information about the new user (e.g., like a wedding or anniversary date, dates of vacation, retirement date, etc.) may be inferred for the new user based on content paths were (or are) created by an existing user.

In some embodiments, the content path system 102, or component thereof, like the event subsystem 120 may analyze event data 140 to determine whether to update permissions of a user to access one or more content paths. For example, the event subsystem 120 may determine whether a user got engaged, married, graduated, or otherwise met a condition upon which access to a content path is governed. In turn, the event subsystem 120 may determine a notification by which the user is notified of the availability to access a content path or a portion of the content path. For example, the display subsystem 118 may generate an interface that indicates to the user that a new content path or portion thereof is available to access by the user.

In some embodiments, the event subsystem 120 may analyze event data 140 to determine whether to promote access to a content path or portion thereof by one or more users. For example, the event subsystem 120 may execute one or more computer program models to detect (e.g., infer) whether an event has occurred based on ingested event data. For example, the event subsystem 120 may interface with the training subsystem 114 to train one or more models, which may include audio classification models, image classification models, optical character recognition models, and NLP models, or other machine learning models (e.g., any model described elsewhere herein) for analyzing ingested event data 140. For example, the training subsystem 114 may train one or more neural networks or other models for processing audio, image, text data, or other data associated with ingested content (or content uploaded or created on the content path system 102) to identify events. Examples of neural networks that can be trained may include, but are not limited to recurrent neural networks, convolutional neural networks, artificial neural networks, among others, which may be trained to process natural language texts or other inputs, like other types of input content. Example models like those which may be used to evaluate content items uploaded by users may be trained (e.g., in accordance with techniques like those described herein) and employed to analyze a variety of content to detect events. Thus, for example, the event data 140 may include content which may used as training data 134 to train one or more computer models to detect events.

As described previously, the training subsystem 114 may store, access, or update one or more models in various states of training from within the framework database 130. For example, the training subsystem 114 may access a previously trained machine learning model (or a model undergoing training) and update the model based on newly received (or classified data) and store an updated version of the model within the framework database 130. The training subsystem 114 may access a trained model to process data which in turn may be used to train another model. Thus, the training subsystem 114 may store or access data within the framework database 130, such as data of one or more models 132 and training data 134, and the training subsystem 114 may process such data to train models by which event data 140 may be processed to identify new events (e.g., recent or current events). User feedback data, like explicit or implicit indications of whether a promoted content path or portion thereof is relevant to a detected event may be used to further augment event data 140, which may be used as training data 134 to iteratively train one or more models. In some examples, interactions of users, like implicit feedback based on users accessing a content path that is promoted in relation to a detected event, or other feedback mechanisms like explicit ratings of whether a content path is relevant to a detected event or a measure of quality or importance of a detected event may be processed to improve event detection and promotion of relevant content paths or portions thereof.

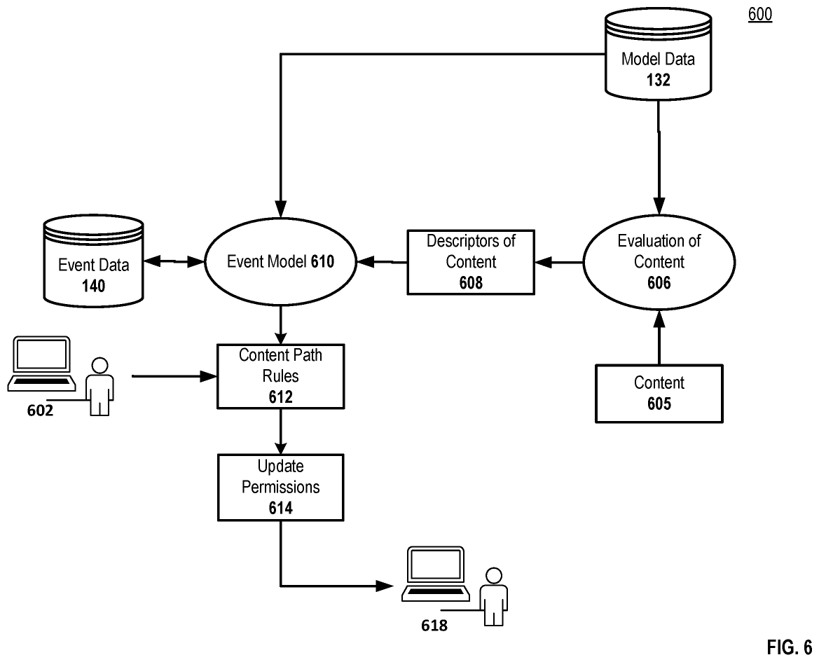

FIG. 6 is an example environment 600 for time and event delayed sharing of content within which the present techniques may be implemented in accordance with some example embodiments. In some embodiments, content 605 may be ingested by a system, like a content path system, for evaluation, such as by an event subsystem. Examples of ingested content may include, but is not limited to, content items, such as those uploaded by users for creation of content paths, as well as other sources of content, such as from feeds, like Really Simple Syndication feeds, from crawling of webpages, among other online media sources, or from one or more corpuses of content. Ingested content may include text, image, video, or other content, and some content may include multiple types of content (e.g., a webpage may include text and image content, or other embedded content, like video or audio).

Embodiments may evaluate ingested content 606 to determine information about the content, such as by analyzing ingested content by one or more machine learning or other models as described herein. For example, the system may determine descriptors of the content item, like what is depicted in an image, in different portions of a video, discussed or heard in audio, or described in a natural language text. The system may evaluate 606 different types of the content in different ways, such as based on the type of content item. For example, based on a type of content item, one or more models may be selected from the model data 132 to process the content item. The output of the processing may comprise descriptors 608, or in some cases, a description of the content item. The descriptors may include metadata indicative of timestamps, date, time, or location that may be inferred from the content.

For user uploaded content, such as in relation to creating a content path, a user may be requested to indicate whether the descriptors or description is accurate, and may optionally modify the descriptors or description. Accordingly, in some examples, analysis of some content, like user uploaded content, may be performed by similar processes implemented in connection with other aspects of a content path system. For example, descriptors of user uploaded content may be determined in connection with user creation of content paths, and descriptors of content ingested by the system from other sources may be determined when that other content is ingested or periodically (e.g., batch processing of ingested content twice a day, once a day, once a week, or in accordance some other schedule, or after a threshold number of content is ingested).

For content ingested from other sources, like feeds, webcrawlers, or corpuses (e.g., repositories), which may include unstructured or structured data, the evaluation of content 606 may be unsupervised (which is not to suggest that evaluation of content items uploaded by users must be supervised) and the descriptors or descriptions generated may include multiple different possibilities of descriptors or descriptions or metadata fields. In either case, the descriptors may be associated with ingested content in a data structure, such as records corresponding to different content from which events may be inferred. In examples where some content, like a webpage, includes multiple types of content (e.g., like image and text), multiple records may be generated in relation to the different content types and associated (e.g., by reference to each other or a parent record corresponding to the webpage), or the information may be stored in a single record that includes information for multiple content types (e.g., a record may include fields corresponding to multiple content types and instances of content).

An event model 610 may determine which content relates to different types of events or specific events (e.g., historical events, current events, etc.). For example, the event model 610 may score a plurality of events for different ones of the content items based on the descriptors and metadata (e.g., based on timestamps, date, time, or location, some of which may be obtained from EXIF data, etc.) associated with the content (e.g., using the records corresponding to the content). Some embodiments may cluster, such as prior to scoring events for content, content records based on one or more descriptors of content, such as to identify clusters of related content items. In some examples, the clustering may occur across multiple dimensions, like across a plurality of characteristics describing the content in the records of content, which may be used to determine in which dimensions one piece of content relates (or does not relate) to one or more other pieces of content. An obituary for a veteran, for example, might be clustered with records corresponding to content like articles about historical events (e.g., battles or engagements) based on one subset of characteristics but also records corresponding to content like a wedding of the veteran with a spouse based on another subset of characteristics. During a training phase of the event model 610, event types corresponding to different content items may be determined, and in some examples a candidate event type for a content item may be inferred based on the event types of content items within a cluster to which the content item is determined to belong (e.g., based on a measure of similarity, like a Euclidian distance or cosine similarity metric). In some examples, a clustering process, in a second phase, may also cluster records of content based on their measures of similarity to content clusters across the different dimensions (or combinations of dimensions). As an example, obituaries of married veterans (or obituaries at a higher level of granularity) may cluster similarly across different subsets of characteristics, such as to a plurality of different clusters corresponding to different event types as the obituary may include textual content covering many aspects of the life of the veteran. Thus, the measures of similarity between the content and other content across different subsets of characteristics may be used (e.g., as characteristics themselves) in a second phase of clustering for content that may be clustered in different ways in a first phase. In either case, candidate event types and properties thereof may be determined for content based on other content within a same cluster.

The event model 610 model may use one or more machine learning models to classify content as corresponding to a type of event. For example, a neural network may take as input descriptors corresponding to content, optionally information about measures of similarity between the content and other content, and output an event type and information corresponding to an event type. For example, an output may indicate that the content relates to a birthday party that occurred at a given place at a given time to celebrate a person turning 30 years old, or an output may indicate that the content relates to a celebration of life, graduation, anniversary, or other event. In another example, an output may indicate that the content relates to a historical event, like an accounting of someone's experience when the Berlin Wall fell, or a current event, like an account of someone's experience at a protest, music festival, or other recent or ongoing event. As described previously, users may be prompted to upload content and indicate whether descriptors determined by the system accurately describe the uploaded content, and the user may indicate whether the content corresponds to a given event type, like a birthday, or other event. Records corresponding to content for which an event type is confirmed by a user may be selected to training and validation sets, such as in an initial training operation, by which a machine learning model is trained to classify other content (e.g., prior to or without user supervision) based on the descriptors (or other characteristics, like measures of similarity) determined about the content.

In some examples, an event model 610 may execute an NLP model to output a statement that summarizes an event, such as based on descriptors of content or text of content determined to correspond to the event. For example, a collection of content classified as corresponding to an event (e.g., like a protest in a given location) may be analyzed by the NLP model to summarize what occurred at the event. In another example, a collection of content classified as corresponding to a birthday celebration of a user may be analyzed by the NLP model to summarize information about the birthday (e.g., user A's 30^{th} birthday celebration on 5 Jul. 2022 at Daytona Beach). In some examples, the NLP model may implement an attention mechanism to bias output text (e.g., of a summary/prose description of the event) to relate back to the inputs. In some examples, at least some of the content items in a collection may be ordered, such as temporally (e.g., timestamps of images or video), to facilitate a temporally consistent summarization.

Classifications of content as corresponding to an event, and information determined about events, may be stored as event data 140. For example, records of determined events may be stored as event data 140. Additionally, records of corresponding to users of the system that participated in, or were the focus of an event (e.g., birthday celebration, or other event type), may be stored as event data, and the information determined about events may be used to populate some of those records of users to indicate information about the users by which dynamic content path rules 612 may be implemented. For example, if a user creates a content path (or portion thereof) to which user A is to be granted access to upon graduation from high school, the event model 610 may determine that content ingested by the system indicates that user A graduated high school, and a record of the user may be updated to indicate a known (or inferred date) of the graduation based on that content.

Examples of models described above may include one or more models like those described above with reference to FIG. 3, or other models described above. Example models may be machine learning models that are trained and executed by one or more systems or subsystems like those depicted in FIG. 1 to process inputs and generate outputs, such as the content path system 102 or event subsystem 120. An example of a machine learning model consistent with the present techniques is described above with respect to FIG. 3. In some examples, one or more of the models trained and employed in connection with the environment described with reference to FIG. 6 may include models like those discussed with reference to the environment of FIG. 2, which is not to suggest that one or more of such similar models are not trained to process inputs and generate outputs specific to the respective technical solutions, or that different models cannot be used.

As shown, a user 602 may use specify, or select, content path rules 612, like specific rule sets, which may include one or more dynamic rules to trigger access to a content path or portion of a content path (e.g., created by the user) by one or more other users responsive to events. In some examples, these rules may be a combination of specific dates and one or more users or user groups, such as where a future date (e.g., a birthday or anniversary) is known, or an event and one or more users of user groups, such as where a future date, or even a user to which the rule applies, may not yet be known to the user 602 specifying the rule.

Example content path rules 612 may specify criteria by which access to a content path or portion thereof is to be granted to one or more users or user groups. Some examples of rules may be specific events (or dates), like a specific birthday, high school graduation, college graduation, wedding, wedding anniversary, and the like. Some examples of rules may be relevancy to an event, like whether to share a content path or portion thereof based on current events. For example, a user creating a content path detailing an experience of working on an election campaign may elect to permit sharing of the content path to one or more user groups based on the relevancy of that experience to a current event, like retirement of the politician, re-election of the politician, or in memory of the politician. In another example, a user creating a content path detailing an experience of working in Greenland to analyze the movement of glaciers may elect to permit sharing of the content path based on relevant to current events, which might include a popular news article or study detailing the effects of climate change on glaciers in Greenland, or legislation relevant to climate change. Measures of relevancy may be determined by the event model 610, such as based on identification of an event to which ingested content relates and which content paths relate to that content, or if a content path is popular among users, or a group of users of the system, which other content paths are related to that content path (e.g., such that user's may further explore an event or theme).

In addition to specifying rules governing when or how access is to be granted, example content path rules 612 may further specify to which user or group of users those rules are to apple. For example, content path rules 612 may permit user 602 to specify different rules governing when or how access is to be granted to a content path or portion thereof for different users and user groups, like grandchildren, coworkers, friends, etc., specific users, or a combination thereof. For example, a grandmother may specify that a grandchild is to be permitted access to different portions of a content path at different milestones of that grandchild's life, and that family members are to be permitted access to a subset of those portions of the content path one or more days, weeks, or months after. In another example, the grandmother may specify that family members and friends are to be permitted access to a content path, such as upon her death, and a subset of that content path may be available to be accessed by all users a week, month, or years later. In some cases, a user may specify a user group that may be updated, such as to include family members that become users of the system, like at a later date, which in some examples may occur automatically in response to identification of the new user to the group by the system (optionally confirmed by the user, or one or more other current users in the group, such as other family members that are already users of the system). Other user groups (e.g., alumni of a given school) may similarly be updated to include new users (or existing users) upon identification of a user to a group. Identification of a new or existing user to a user group may performed automatically, such as responsive to relationships formed between that user to other users of the system, which may be requested by a user or determined by the system based on content uploaded to (or ingested by) the system or collaborations of users on content paths.

The system may update permissions 614 for one or more users to access one or more content paths or portions thereof based on the content path rules 612 and event data 140 records. Event data 140 may be analyzed, such as periodically, or in response to identifying an event or updating a user record based on an event, to determine whether the criteria of one or more rules specified for sharing a content path or portion thereof have been met based on the records corresponding to events and users. For example, a 618 user may create a content path for their engagement and wedding planning experience leading up to their wedding, and a record of the user may be updated to reflect events like an engagement status and date, and later a planned wedding date. In turn, the system may determine whether any content path rules 612 specified for content paths created by other users 602 apply to the user 618, and whether the record of the user and records of the events (e.g., engagement, or planned wedding date), satisfy the rule criteria to permit the user to access the content path or a portion thereof. If the rule criteria is satisfied, the system may updated permissions 614 of the user 618 to grant the user access to the content. In some embodiments, updating of permissions 614 by the system causes the system to notify the user 618 (or a plurality of users) of the content path or portion thereof that is newly accessible.

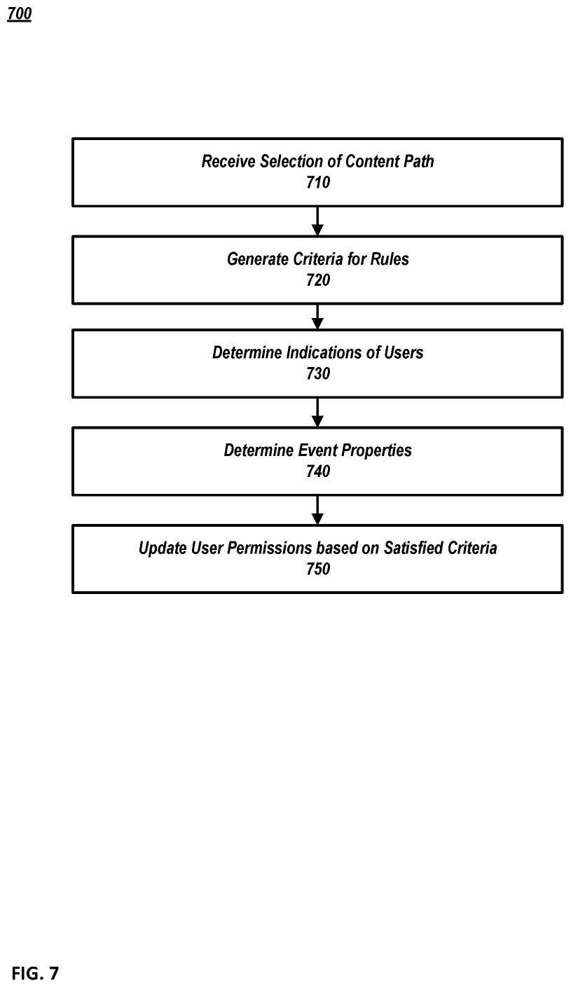

FIG. 7 is an example process 700 for time and event delayed sharing by which the present techniques may be implemented. Embodiments of the process may be implemented by a content path system like that described with reference to FIG. 1, such as upon a computing device like that described with reference to FIG. 8. Embodiments may perform some or all of the steps of the process 700, or other functions descripted herein, and may perform steps in a different order than illustrated.

In step 710, embodiments of the process may include receiving a selection of a content path or one or more portions of a content path. For example, a content path created by a user may cover different sub-contexts, include various content items, or other information which the user may desire to selectively permit access (e.g., to reveal a portion to some users but not other users) or to reveal some portions at a first time and other portions at a second time to some users. Accordingly, embodiments may provide an interface by which users may view a data structure of a content path, such as different path nodes corresponding to content or sub-contexts including one or more such path nodes, which the user may select. In some examples, the interface may permit a user to select a sub-context, a grouping of path nodes having related descriptors which may span across sub-contexts, a set of temporally ordered path nodes, or a set of path nodes in order of their presentation. As an example, a content path created by a grandmother to celebrate life milestones of a grandchild (or multiple grandchildren) may have different sub-contexts corresponding to different life milestones (e.g., 18^{th} birthday, high school graduation, college graduation, engagement, wedding, etc.). One or more of the sub-contexts may comprise path nodes corresponding to different grandchildren (e.g., the grandmother may create or upload different content for a granddaughter than a grandson for a wedding), and one or more of the sub-context may comprise a path node applicable to both grandchildren (but which may comprise dynamic content as described previously to modify the content, such as with different names, pronouns, institution, etc.). An interface may provide different options for the user to select portions of the content path (e.g., one or more path nodes, sub-contexts, etc.) automatically (or manually) based on factors like those described above.

In step 720, embodiments of the process may include generating criteria for rules based on an event type for a selected portion (which may be some, or all) of a content path. For example, a user may desire to create a rule that permits access to a selected portion of a content path relating to birthday wishes for turning 18 years old. An example event type, like birthday, may permit a user to select a year (or the year may be inferred from the content by the process) of the birthday (e.g., 18^{th} year). Other event types consistent with the present example may correspond to other life milestones nodes above, among others, which may be selected for other portions of the content path. In some examples, an applicable event type (or types) and criteria may be inferred based on an analysis of content items within the selected portion of the content path (e.g., based on descriptors of the content items). For example, the process may determine an event type and rule criteria based on content items determined to have descriptors indicative of wishing a grandson a happy 18^{th} birthday. In some examples, a user may configure a new event type, such as by manually configurating rules and specifying criteria. Embodiments of the process may determine event types from content paths of users based on an analysis of contexts and sub-contexts for which content paths are created, and also based on the analysis of content ingested from other sources. Embodiments of the process are not limited to the above examples. Indeed, various other example events, rules, and criteria are described herein and applicable to various example selections of portions of content paths consistent with embodiments of the process.

In step 730, embodiments of the process may determine indications of users to which criteria for one or more rules apply. For example, the process may infer, based on relationships formed between the user and other users, which ones of the other users or groups of users should be permitted access to the selected portion of the content path when criteria of the one or more rules is met. In some embodiments, the user may permit the process to make inferences about future users that should be permitted access, such as future grandchildren or great grandchildren before they are born or otherwise registered as users. In some embodiments, an interface displays options for explicit (e.g., manual) selections of users or groups of users to which criteria for one or more rules apply. Thus, for example, a user or group of users (or criteria for a future user) may be associated with one or more rules and criteria.

In step 740, embodiments of the process may determine event properties, such as to determine whether the properties of identified events satisfy criteria of one or more rules. In some examples, event properties may be determined based on ingested content, which may include content items uploaded by users in association with creating content paths or content ingested from other sources, various examples of which are described herein. The process may analyze ingested content to determine whether content corresponds to an event type and properties thereof. For example, the process may analyze content to determine descriptors of content, as described herein, whether those descriptors are indicative of an event, and which descriptors correspond to properties of the event. In some examples, the process may determine properties of an event based on records of users, which may be updated based on analysis of ingested content, such as from content paths created by the user or related users, or user provided information (e.g., like a birthdate, wedding or anniversary date, etc.) stored within records of users. An example event and properties may be a determination that a user graduated college with a given degree conferred on a given date from a given institution, or that a user had or is celebrating a birthday on a given date and turning a given age based on a birth date. Other examples of events and their properties are described herein (but the process should not be construed as limited to only the above or other examples).

In step 750, embodiments of the process update user permissions based on rule criteria satisfied by properties of an event. For example, a rule (e.g., for a birthday) with criteria (e.g., 18 years old) for permitting access by a given user may be determined as being met responsive to an event based on its determined properties (e.g., the given user is having or had an 18^{th} birthday). Embodiments of the process may determine to which users an event and one or more of its associated properties are applicable and then determine for each user whether it satisfies criteria of rules governing the user's permissions to access a portion of a content path. In response to a determination that the event satisfies the criteria for the user to access the portion of the content path, the process updates permissions of the user to permit the user access to the portion of the content path. In some examples, the process updates an interface accessed under an account of the user to indicate that the portion of the content path is available for access. The process may, in some examples, notify the user that the portion of the content is newly available and indicate why the portion of the content is now available for access (e.g., “A content path is now available on your 18^{th} Birthday”).

FIG. 8 is a physical architecture block diagram that shows an example of a computing device (or data processing system) by which some aspects of the above techniques may be implemented. Various portions of systems and methods described herein, may include or be executed on one or more computer systems similar to computing system 1000. Further, processes and modules or subsystems described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A computer-implemented method for sharing content, the method comprising:
receiving a selection of a portion of content within a content path;
generating rule criteria for an event based on an event type for the selected portion of content;
determining indications of users to apply rule criteria of the event based on the event type;
analyzing obtained content to determine descriptors for the obtained content;
determining, based on a set of descriptors corresponding to a portion of the obtained content, that the set of descriptors are indicative of the event;
determining, for at least one of the users, that one or more of the descriptors in the set of descriptors satisfy the rule criteria of the event for the user; and
updating, in response to the determination, permissions of the user to permit the user access to the portion of the content within the content path.

2. The computer-implemented method of claim 1, wherein:
the content path comprises a plurality of nodes, each corresponding to one or more content items within the content path, and
each of the plurality of nodes is associated with descriptors indicative of the one or more content items corresponding to the node.

3. The computer-implemented method of claim 2, wherein receiving a selection of a portion of content within a content path comprises:
identifying a subset of nodes within the content path based on edge parameters of edges formed between nodes within the subset of nodes.

4. The computer-implemented method of claim 3, further comprising:
forming the edges between the node within the subset of nodes based on the descriptors corresponding to the respective nodes.

5. The computer-implemented method of claim 3, further comprising:
forming the edges between the nodes within the subset of nodes based on a shared context of the respective nodes.

6. The computer-implemented method of claim 3, further comprising:
forming the edges between the nodes within the subset of nodes based on a temporal ordering of the respective nodes.

7. The computer-implemented method of claim 2, wherein receiving a selection of a portion of content within the content path comprises:
receiving a selection of the content path, or
receiving a selection of a subset of nodes within the content path.

8. The computer-implemented method of claim 1, wherein generating rule criteria for an even based on an event type for the selected portion of content comprises:
determining one or more candidate event types for the selected portion of content based on descriptors of the selected content.

9. The computer-implemented method of claim 8, further comprising determining one or more descriptors for a content item, the determining comprising one or more of:
classifying one or more objects or a scene depicted in image data to obtain text descriptors;
classifying optical characters depicted in image data to obtain text descriptors;
classifying audio to obtain text descriptors; or
processing natural language text to obtain text descriptors.

10. The computer-implemented method of claim 9, wherein receiving a selection of a portion of content within a content path further comprises:
determining candidate selections of different portions of content within the content path based on the descriptors;
receiving a selection of a candidate selection corresponding to the portion of the content within the content path;
displaying the one or more candidate event types corresponding to the portion of the content responsive to the candidate selection; and
receiving a selection of a candidate event type.

11. The computer-implemented method of claim 10, further comprising:
generating the rule criteria based on the selected candidate event type.

12. The computer-implemented method of claim 1, wherein determining indications of users to apply rule criteria of the event based on the event type comprises:
identifying, based on the event type and relationships between a user creator of the content path and other users, one or more other users or types of users to which the event is applicable.

13. The computer-implemented method of claim 12, further comprising:
determining that a new user corresponds to a type of user to which the event is applicable based on relationships formed between the new user and the user creator or the one or more other users; and
determining to apply the rule criteria of the event to the new user.

14. The computer-implemented method of claim 1, wherein analyzing obtained content to determine descriptors for the obtained content comprises obtaining one or more of content items of other content paths, or content ingested from a feed or webcrawler, the analyzing further comprising:
classifying one or more objects or a scene depicted in image data to obtain text descriptors;
classifying optical characters depicted in image data to obtain text descriptors;
classifying audio to obtain text descriptors; or
processing natural language text to obtain text descriptors.

15. The computer-implemented method of claim 14, wherein determining, based on a set of descriptors corresponding to a portion of the obtained content, that the set of descriptors are indicative of the event comprises:
determining the set of descriptors correspond to the event type; and
determining that one or more of the descriptors in the set of descriptors correspond to the at least one of the users.

16. The computer-implemented method of claim 15, wherein determining that the one or more of the descriptors in the set of descriptors satisfy the rule criteria of the event for the user comprises:
comparing properties of the descriptors in the set of descriptors that correspond to the user with the rule criteria; and
determining whether the comparison indicates satisfaction of the rule criteria.

17. The computer-implemented method of claim 1, wherein determining that the one or more of the descriptors in the set of descriptors satisfy the rule criteria of the event for the user comprises:
updating a record of the user based on the one or more of the descriptors in the set of descriptors corresponding the user;
storing a record of the event; and
determining whether properties of the record of the user and the record of the event satisfy rule criteria governing access of the user to one or more content paths.

18. The computer-implemented method of claim 1, wherein updating, in response to the determination, permissions of the user to permit the user access to the portion of the content within the content path comprises:
notifying the user of permission to access the portion of the content within the content path.

19. The computer-implemented method of claim 1, wherein updating, in response to the determination, permissions of the user to permit the user access to the portion of the content within the content path comprises:
updating an interface accessible under an account of the user to indicate permission to access the portion of the content within the content path.

20. A non-transitory computer-readable medium storing computer program instructions that when executed by one or more processors effectuate operations comprising:
receiving a selection of a portion of content within a content path;
generating rule criteria for an event based on an event type for the selected portion of content;
determining indications of users to apply rule criteria of the event based on the event type;
analyzing obtained content to determine descriptors for the obtained content;
determining, based on a set of descriptors corresponding to a portion of the obtained content, that the set of descriptors are indicative of the event;
determining, for at least one of the users, that one or more of the descriptors in the set of descriptors satisfy the rule criteria of the event for the user; and
updating, in response to the determination, permissions of the user to permit the user access to the portion of the content within the content path.
